(19) United States
(12) Patent Application Publication
(10) Pub. No.: US 2025/0279876 A1
(43) Pub. Date: Sep. 4, 2025

(54) REGISTRATION REQUEST DEVICE, SEARCH REQUEST DEVICE, REGISTRATION REQUEST METHOD, SEARCH REQUEST METHOD, AND DATA MANAGEMENT METHOD

(71) Applicant: Mitsubishi Electric Corporation, Tokyo (JP)

(72) Inventor: Takato HIRANO, Tokyo (JP)

(73) Assignee: Mitsubishi Electric Corporation, Tokyo (JP)

(21) Appl. No.: 19/210,456

(22) Filed: May 16, 2025

Related U.S. Application Data
(63) Continuation of application No. PCT/JP2022/048442, filed on Dec. 28, 2022.

(51) Int. Cl. H04L 9/06

(52) U.S. Cl. CPC H04L 9/0618

(57) ABSTRACT

A registration request device (500) generates an aggregate attribute condition by adding a higher-level attribute condition that includes at least one of a plurality of attribute conditions indicating attributes that enable a search for a ciphertext to the plurality of attribute conditions. The registration request device (500) generates an encrypted tag indicating a search condition in which attribute conditions included in the generated aggregate attribute condition are connected by a logical operator OR, and being used to realize a search for the ciphertext. The registration request device (500) registers the encrypted tag in association with the ciphertext in a data management device (700).

### CROSS REFERENCE TO RELATED APPLICATION

This application is a Continuation of PCT International Application No. PCT/JP2022/048442, filed on Dec. 28, 2022, which is hereby expressly incorporated by reference into the present application.

### TECHNICAL FIELD

The present disclosure relates to a searchable encryption technique using common-key encryption.

### BACKGROUND ART

Searchable encryption is a technique to search for encrypted data while the encrypted data remains encrypted. In other words, searchable encryption is a technique to search for encrypted data without decrypting the encrypted data.

In recent years, searchable encryption has gained attention as a security technique to protect confidential information from eavesdropping by malicious administrators or malware in cloud services. In other words, searchable encryption has gained attention as a security technique in managing data in cloud services.

As processing in searchable encryption, processing by a registrant, processing by a searcher, and processing by a data management device will be described. The registrant is a user who registers encrypted data. The searcher is a user who searches for encrypted data.

The basic flow of processing by the registrant is as follows.

First, the registrant encrypts data to generate a ciphertext. This ciphertext is used to decrypt and restore the original data. Next, the registrant encrypts a keyword for performing a secret search for the ciphertext. The encrypted keyword is referred to as an encrypted tag. It is difficult to infer the keyword from the encrypted tag. Next, the registrant associates the encrypted tag with the ciphertext. There is no need for the number of encrypted tags to be one, and multiple encrypted tags can be associated with the ciphertext. Then, the registrant registers the ciphertext and the encrypted tag in the data management device.

The basic flow of processing by the searcher is as follows.

First, the searcher selects a keyword to be searched for. Next, the searcher uses a secret key of the searcher to randomize the keyword. The randomized keyword is referred to as a search query. It is difficult to infer the secret key from the search query. Next, the searcher transmits the search query to the data management device to request a search from the data management device. Then, the searcher receives a ciphertext that matches the search query from the data management device.

The basic flow of processing by the data management device is as follows.

Multiple pairs of ciphertexts and encrypted tags are registered in the data management device.

First, the data management device receives a search query. Next, the data management device performs a special operation on the search query and each registered encrypted tag to select an encrypted tag that matches the search query. That is, in the special operation, the keyword of the search query can be compared with the keyword of each encrypted tag without decrypting the encrypted tag and the search query. This special operation is called searchable encryption. Then, the data management device transmits a ciphertext associated with the selected encrypted tag.

There are two types of searchable encryption: a common-key scheme and a public-key scheme.

In the common-key scheme, a common-key encryption technique is used, and registrants and searchers are limited.

In the public-key scheme, a public-key encryption technique is used, and searchers are limited, but registrants are not limited.

In many common-key schemes, a registrant and a searcher share the same secret key.

In Patent Literature 1, a registrant and a searcher each own different secret keys, and the registrant can specify a searcher who is allowed to perform decryption and searches in each of a ciphertext and an encrypted tag. Such a common-key scheme is called a multi-user type common-key scheme. That is, the multi-user type common-key scheme is equipped with an access control function.

In a typical common-key scheme, a registrant and a searcher own the same secret key. Therefore, the searcher can perform searches and decryption on all ciphertexts and encrypted tags.

On the other hand, in the multi-user type common-key scheme, a registrant and a searcher own different secret keys, and furthermore each searcher owns a different secret key. Even a searcher who owns a secret key cannot perform decryption and searches if the conditions for a searcher specified in the ciphertext and the encrypted tag are not met.

Furthermore, in the multi-user type common-key scheme, it is difficult for a malicious attacker to change the searcher specified in the ciphertext and the encrypted tag to another searcher without permission. In this way, the multi-user type common-key scheme achieves higher security than the typical common-key scheme.

### CITATION LIST

### Patent Literature

Patent Literature 1: JP 6910477 B

Patent Literature 2: JP 6384149 B

### SUMMARY OF INVENTION

### Technical Problem

Patent Literature 1 describes a multi-user type common-key scheme in which a searcher who is allowed to perform decryption and searches can be efficiently specified with awareness of a hierarchical structure by using a wildcard. For example, in a company, when a general employee is specified as a searcher for a ciphertext and an encrypted tag using this scheme, it is possible to efficiently specify that a supervisor of the general employee, such as a section manager or department manager, is also allowed to perform decryption and searches.

However, if multiple searchers without a hierarchical structure are to be specified in this scheme, the data sizes of a ciphertext and an encrypted tag become large, incurring search processing costs, or each searcher ends up owning multiple secret keys, incurring operational costs. For example, if it is to be specified that a general employee A and a general employee B in the same department and also their supervisor are allowed to perform decryption and searches, the above cost issues arise.

Patent Literature 2 describes an encryption scheme in which the data size does not increase even if the conditions for a searcher become complex using a logical operator such as OR.

However, this scheme only allows specifying a searcher who can decrypt a ciphertext, and lacks the function to generate an encrypted tag for performing searchable encryption, making it a problem to support searchable encryption. Furthermore, since this scheme is constructed based on the public-key encryption technique, even if the above problem is solved, processing speed becomes a problem.

The present disclosure aims to make it possible to realize a multi-user type common-key scheme that allows specifying a searcher who is allowed to perform decryption and searches using a logical operator OR, while achieving efficient search performance even if such a specification is made.

### Solution to Problem

A registration request device according to the present disclosure includes
an aggregate condition generation unit to generate an aggregate attribute condition by adding a higher-level attribute condition that includes at least one of a plurality of attribute conditions indicating attributes that enable a search for a ciphertext to the plurality of attribute conditions; and
an encrypted tag generation unit to generate an encrypted tag indicating a search condition in which attribute conditions included in the aggregate attribute condition generated by the aggregate condition generation unit are connected by a logical operator OR, the encrypted tag being used to realize a search for the ciphertext.

### Advantageous Effects of Invention

In the present disclosure, an encrypted tag is generated which indicates a search condition in which a plurality of attribute conditions indicating attributes that enable a search for a ciphertext and also a higher-level attribute condition including at least one of the plurality of attribute conditions are connected by a logical operator OR. As a result, it is possible to realize a multi-user type common-key scheme in which a searcher who is allowed to perform decryption and searches can be specified using a logical operator OR, and high search efficiency can be achieved even with such a specification.

### BRIEF DESCRIPTION OF DRAWINGS

FIG. 1 is a configuration diagram of a searchable encryption system 100 according to Embodiment 1.

FIG. 2 is a configuration diagram of a master key generation device 200 according to Embodiment 1.

FIG. 3 is a configuration diagram of a registration key generation device 300 according to Embodiment 1.

FIG. 4 is a configuration diagram of a user key generation device 400 according to Embodiment 1.

FIG. 5 is a configuration diagram of a registration request device 500 according to Embodiment 1.

FIG. 6 is a configuration diagram of a generation unit 520 according to Embodiment 1.

FIG. 7 is a configuration diagram of a search request device 600 according to Embodiment 1.

FIG. 8 is a configuration diagram of a data management device 700 according to Embodiment 1.

FIG. 9 is a flowchart of overall processing by the searchable encryption system 100 according to Embodiment 1.

FIG. 10 is a flowchart of a master key generation process according to Embodiment 1.

FIG. 11 is a flowchart of a registration key generation process according to Embodiment 1.

FIG. 12 is a flowchart of a user key generation process according to Embodiment 1.

FIG. 13 is a diagram illustrating an example of attribute information according to Embodiment 1.

FIG. 14 is a flowchart of a registration request process according to Embodiment 1.

FIG. 15 is a flowchart of a registration operation process according to Embodiment 1.

FIG. 16 is an explanatory diagram of information stored in a storage unit 790 according to Embodiment 1.

FIG. 17 is a flowchart of a search request process according to Embodiment 1.

FIG. 18 is a flowchart of a search operation process according to Embodiment 1.

FIG. 19 is a flowchart of a decryption operation process according to Embodiment 1.

FIG. 20 is a flowchart of a deletion operation process according to Embodiment 1.

FIG. 21 is a configuration diagram of the registration request device 500 according to Embodiment 2.

FIG. 22 is a configuration diagram of a generation unit 520A according to Embodiment 2.

FIG. 23 is a configuration diagram of the search request device 600 according to Embodiment 2.

FIG. 24 is a configuration diagram of the data management device 700 according to Embodiment 2.

FIG. 25 is a flowchart of overall processing by the searchable encryption system 100 according to Embodiment 2.

FIG. 26 is a flowchart of the registration request process according to Embodiment 2.

FIG. 27 is a flowchart of the search request process according to Embodiment 2.

FIG. 28 is a flowchart of the search operation process according to Embodiment 2.

FIG. 29 is a flowchart of the decryption operation process according to Embodiment 2.

FIG. 30 is a configuration diagram of the master key generation device 200 according to Variation 1.

FIG. 31 is a configuration diagram of the registration key generation device 300 according to Variation 1.

FIG. 32 is a configuration diagram of the user key generation device 400 according to Variation 1.

FIG. 33 is a configuration diagram of the registration request device 500 according to Variation 1.

FIG. 34 is a configuration diagram of the search request device 600 according to Variation 1.

FIG. 35 is a configuration diagram of the data management device 700 according to Variation 1.

### DESCRIPTION OF EMBODIMENTS

In the embodiments and drawings, the same reference numerals are assigned to the same elements and corresponding elements. The description of elements with the same reference numerals will be appropriately omitted or simplified. Arrows in diagrams mainly indicate flows of data or flows of processing.

### Embodiment 1

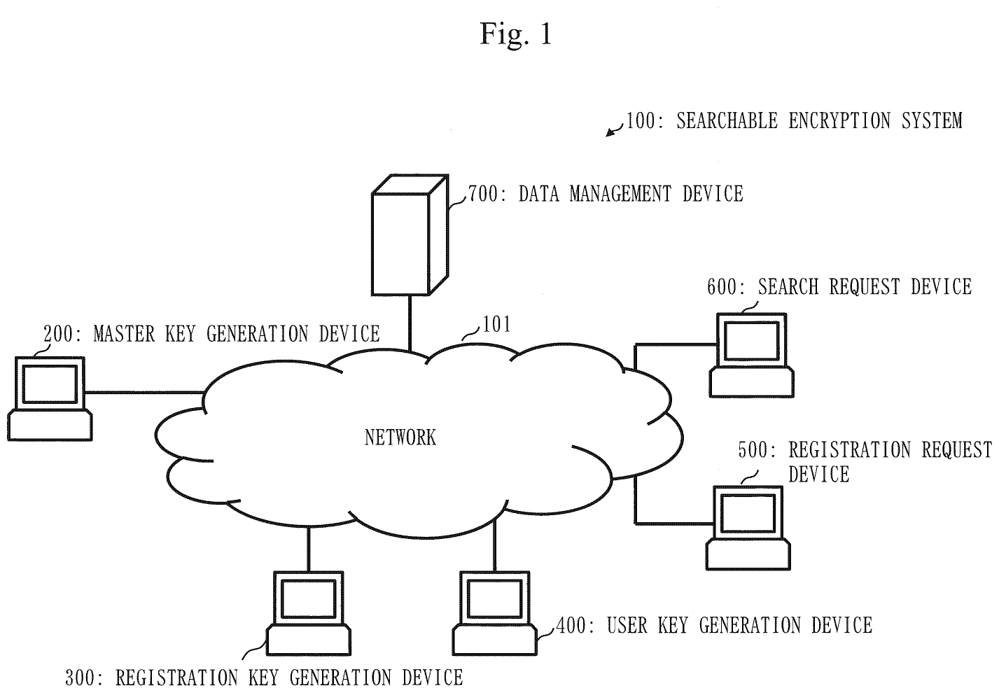

Based on FIGS. 1 to 20, an embodiment will be described in which searchable encryption is performed using a logical operator OR for a searcher who is allowed to decrypt and search for a ciphertext.

### Description of Configuration

Referring to FIG. 1, a configuration of a searchable encryption system 100 according to Embodiment 1 will be described.

The searchable encryption system 100 includes a master key generation device 200, a registration key generation device 300, a user key generation device 400, a registration request device 500, a search request device 600, and a data management device 700.

The devices of the searchable encryption system 100 communicate with one another via a network 101.

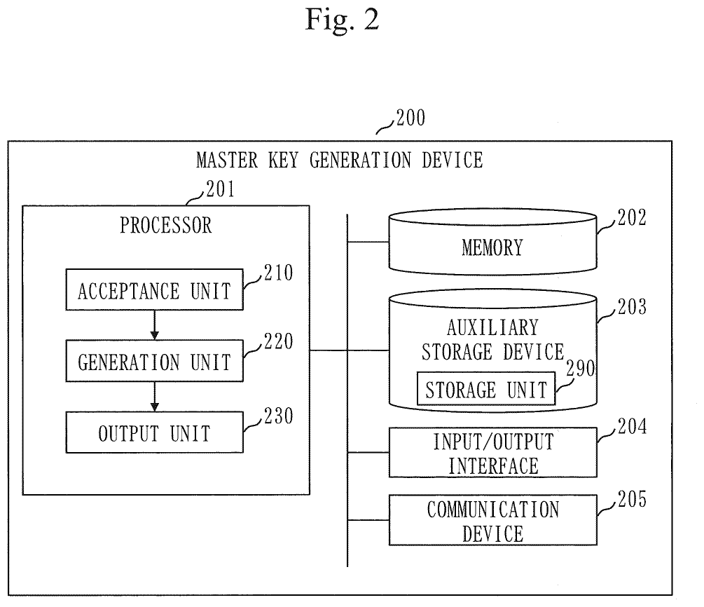

Referring to FIG. 2, a configuration of the master key generation device 200 according to Embodiment 1 will be described.

The master key generation device 200 is a computer. The master key generation device 200 includes hardware such as a processor 201, a memory 202, an auxiliary storage device 203, an input/output interface 204, and a communication device 205. These hardware components are connected with one another via signal lines.

The master key generation device 200 includes elements such as an acceptance unit 210, a generation unit 220, and an output unit 230. These elements are realized by software.

The auxiliary storage device 203 stores a master key generation program to cause a computer to function as the acceptance unit 210, the generation unit 220, and the output unit 230. The master key generation program is loaded into the memory 202 and executed by the processor 201.

Furthermore, the auxiliary storage device 203 stores an OS. At least part of the OS is loaded into the memory 202 and executed by the processor 201. OS stands for operating system. That is, the processor 201 executes the master key generation program while executing the OS.

Data obtained by executing the master key generation program is stored in storage devices such as the memory 202, the auxiliary storage device 203, registers within the processor 201, or a cache memory within the processor 201.

The auxiliary storage device 203 functions as a storage unit 290. However, other storage devices may function as the storage unit 290 instead of the auxiliary storage device 203 or together with the auxiliary storage device 203.

The master key generation program can be recorded (stored) in a computer-readable manner on a non-volatile recording medium such as an optical disc or a flash memory.

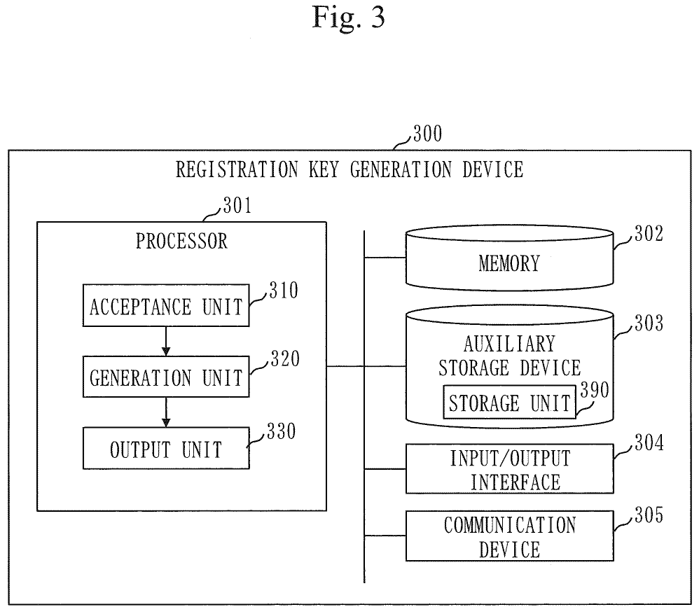

Referring to FIG. 3, a configuration of the registration key generation device 300 according to Embodiment 1 will be described.

The registration key generation device 300 is a computer. The registration key generation device 300 includes hardware such as a processor 301, a memory 302, an auxiliary storage device 303, an input/output interface 304, and a communication device 305. These hardware components are connected with one another via signal lines.

The registration key generation device 300 includes elements such as an acceptance unit 310, a generation unit 320, and an output unit 330. These elements are realized by software.

The auxiliary storage device 303 stores a registration key generation program to cause a computer to function as the acceptance unit 310, the generation unit 320, and the output unit 330. The registration key generation program is loaded into the memory 302 and executed by the processor 301.

Furthermore, the auxiliary storage device 303 stores an OS. At least part of the OS is loaded into the memory 302 and executed by the processor 301. That is, the processor 301 executes the registration key generation program while executing the OS.

Data obtained by executing the registration key generation program is stored in storage devices such as the memory 302, the auxiliary storage device 303, registers within the processor 301, or a cache memory within the processor 301.

The auxiliary storage device 303 functions as a storage unit 390. However, other storage devices may function as the storage unit 390 instead of the auxiliary storage device 303 or together with the auxiliary storage device 303.

The registration key generation program can be recorded (stored) in a computer-readable manner on a non-volatile recording medium such as an optical disc or a flash memory.

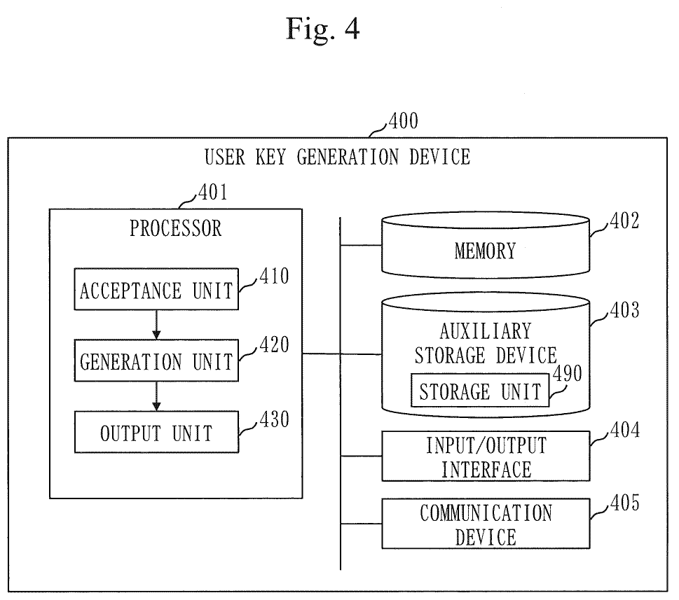

Referring to FIG. 4, a configuration of the user key generation device 400 according to Embodiment 1 will be described.

The user key generation device 400 is a computer. The user key generation device 400 includes hardware such as a processor 401, a memory 402, an auxiliary storage device 403, an input/output interface 404, and a communication device 405. These hardware components are connected with one another via signal lines.

The user key generation device 400 includes elements such as an acceptance unit 410, a generation unit 420, and an output unit 430. These elements are realized by software.

The auxiliary storage device 403 stores a user key generation program to cause a computer to function as the acceptance unit 410, the generation unit 420, and the output unit 430. The user key generation program is loaded into the memory 402 and executed by the processor 401.

Furthermore, the auxiliary storage device 403 stores an OS. At least part of the OS is loaded into the memory 402 and executed by the processor 401. That is, the processor 401 executes the user key generation program while executing the OS.

Data obtained by executing the user key generation program is stored in storage devices such as the memory 402, the auxiliary storage device 403, registers within the processor 401, or a cache memory within the processor 401.

The auxiliary storage device 403 functions as a storage unit 490. However, other storage devices may function as the storage unit 490 instead of the auxiliary storage device 403 or together with the auxiliary storage device 403.

The user key generation program can be recorded (stored) in a computer-readable manner on a non-volatile recording medium such as an optical disc or a flash memory.

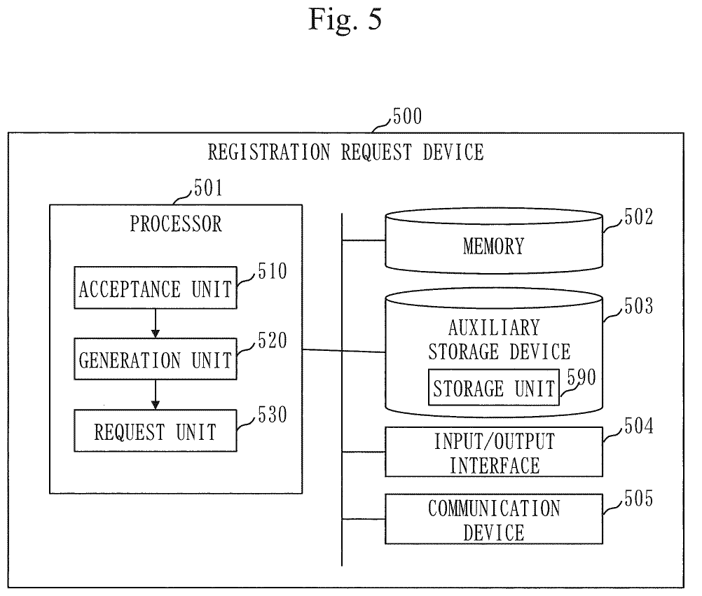

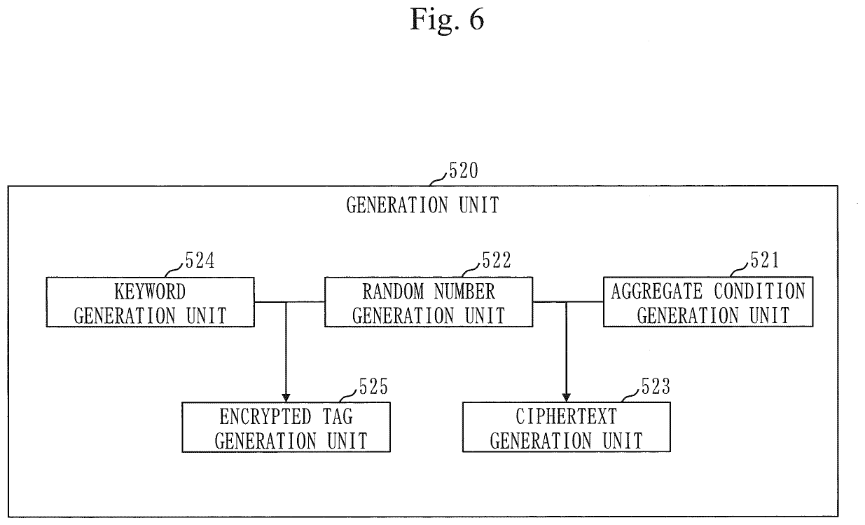

Referring to FIGS. 5 and 6, a configuration of the registration request device 500 according to Embodiment 1 will be described.

The registration request device 500 is a computer. The registration request device 500 includes hardware such as a processor 501, a memory 502, an auxiliary storage device 503, an input/output interface 504, and a communication device 505. These hardware components are connected with one another via signal lines.

The registration request device 500 includes elements such as an acceptance unit 510, a generation unit 520, and a request unit 530. The generation unit 520 includes an aggregate condition generation unit 521, a random number generation unit 522, a ciphertext generation unit 523, a keyword generation unit 524, and an encrypted tag generation unit 525. These elements are realized by software.

The auxiliary storage device 503 stores a registration request program to cause a computer to function as the acceptance unit 510, the generation unit 520, and the request unit 530. The registration request program is loaded into the memory 502 and executed by the processor 501.

Furthermore, the auxiliary storage device 503 stores an OS. At least part of the OS is loaded into the memory 502 and executed by the processor 501. That is, the processor 501 executes the registration request program while executing the OS.

Data obtained by executing the registration request program is stored in storage devices such as the memory 502, the auxiliary storage device 503, registers within the processor 501, or a cache memory within the processor 501.

The auxiliary storage device 503 functions as a storage unit 590. However, other storage devices may function as the storage unit 590 instead of the auxiliary storage device 503 or together with the auxiliary storage device 503.

The registration request program can be recorded (stored) in a computer-readable manner on a non-volatile recording medium such as an optical disc or a flash memory.

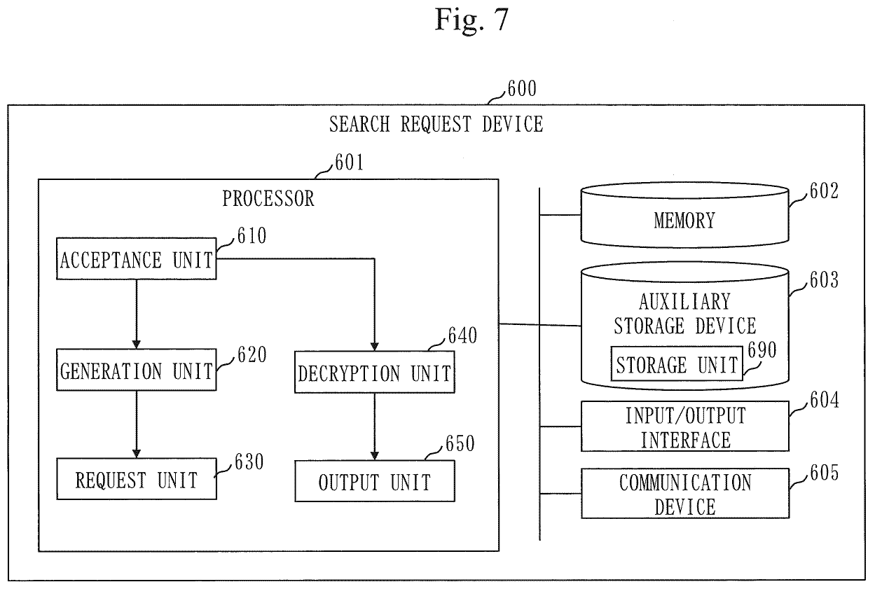

Referring to FIG. 7, a configuration of the search request device 600 according to Embodiment 1 will be described.

The search request device 600 is a computer. The search request device 600 includes hardware such as a processor 601, a memory 602, an auxiliary storage device 603, an input/output interface 604, and a communication device 605. These hardware components are connected with one another via signal lines.

The search request device 600 includes elements such as an acceptance unit 610, a generation unit 620, a request unit 630, a decryption unit 640, and an output unit 650. These elements are realized by software.

The auxiliary storage device 603 stores a search request program to cause a computer to function as the acceptance unit 610, the generation unit 620, the request unit 630, the decryption unit 640, and the output unit 650. The search request program is loaded into the memory 602 and executed by the processor 601.

Furthermore, the auxiliary storage device 603 stores an OS. At least part of the OS is loaded into the memory 602 and executed by the processor 601. That is, the processor 601 executes the search request program while executing the OS.

Data obtained by executing the search request program is stored in storage devices such as the memory 602, the auxiliary storage device 603, registers within the processor 601, or a cache memory within the processor 601.

The auxiliary storage device 603 functions as a storage unit 690. However, other storage devices may function as the storage unit 690 instead of the auxiliary storage device 603 or together with the auxiliary storage device 603.

The search request program can be recorded (stored) in a computer-readable manner on a non-volatile recording medium such as an optical disc or a flash memory.

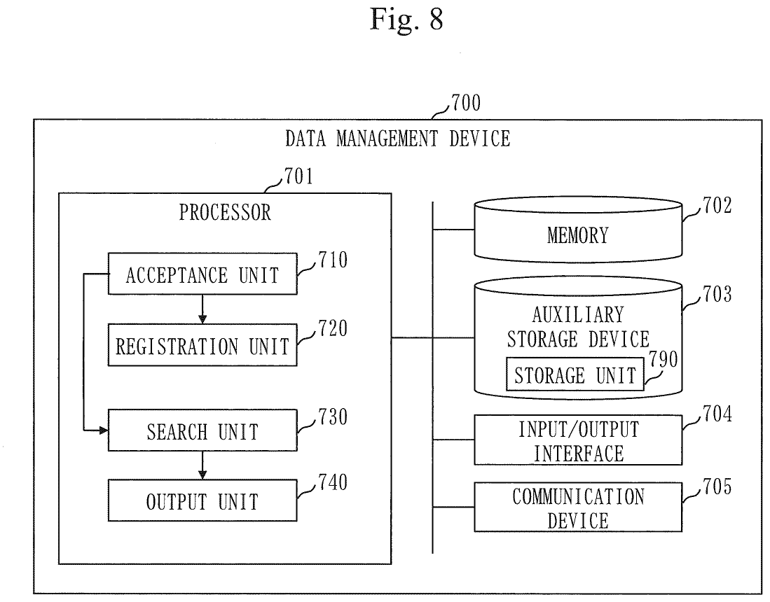

Referring to FIG. 8, a configuration of the data management device 700 according to Embodiment 1 will be described.

The data management device 700 is a computer. The data management device 700 includes hardware such as a processor 701, a memory 702, an auxiliary storage device 703, an input/output interface 704, and a communication device 705. These hardware components are connected with one another via signal lines.

The data management device 700 includes elements such as an acceptance unit 710, a registration unit 720, a search unit 730, and an output unit 740. These elements are realized by software.

The auxiliary storage device 703 stores a data management program to cause a computer to function as the acceptance unit 710, the registration unit 720, the search unit 730, and the output unit 740. The data management program is loaded into the memory 702 and executed by the processor 701.

Furthermore, the auxiliary storage device 703 stores an OS. At least part of the OS is loaded into the memory 702 and executed by the processor 701. That is, the processor 701 executes the data management program while executing the OS.

Data obtained by executing the data management program is stored in storage devices such as the memory 702, the auxiliary storage device 703, registers within the processor 701, or a cache memory within the processor 701.

The auxiliary storage device 703 functions as a storage unit 790. However, other storage devices may function as the storage unit 790 instead of the auxiliary storage device 703 or together with the auxiliary storage device 703.

The data management program can be recorded (stored) in a computer-readable manner on a non-volatile recording medium such as an optical disc or a flash memory.

Each of the processors 201, 301, 401, 501, 601, and 701 is an IC that performs arithmetic processing and controls other hardware components. IC stands for integrated circuit. For example, each of the processors 201, 301, 401, 501, 601, and 701 is a CPU, DSP, or GPU. CPU stands for central processing unit. DSP stands for digital signal processor. GPU stands for graphics processing unit.

Each of the memories 202, 302, 402, 502, 602, and 702 is a volatile storage device. Each of the memories 202, 302, 402, 502, 602, and 702 is also called a main storage or main memory. For example, each of the memories 202, 302, 402, 502, 602, and 702 is a RAM. RAM stands for random access memory. Data stored in the memories 202, 302, 402, 502, 602, and 702 is saved in the auxiliary storage devices 203, 303, 403, 503, 603, and 703, respectively, as needed.

Each of the auxiliary storage devices 203, 303, 403, 503, 603, and 703 is a non-volatile storage device. For example, each of the auxiliary storage devices 203, 303, 403, 503, 603, and 703 is a ROM, HDD, or flash memory. ROM stands for read only memory. HDD stands for hard disk drive. Data stored in the auxiliary storage devices 203, 303, 403, 503, 603, and 703 is loaded into the memories 202, 302, 402, 502, 602, and 702, respectively, as needed.

Each of the input/output interfaces 204, 304, 404, 504, 604, and 704 is a port to which input and output devices are connected. For example, each of the input/output interfaces 204, 304, 404, 504, 604, and 704 is a USB terminal, the input devices are a keyboard and a mouse, and the output device is a display. USB stands for Universal Serial Bus.

Each of the communication devices 205, 305, 405, 505, 605, and 705 is a receiver and transmitter. For example, each of the communication devices 205, 305, 405, 505, 605, and 705 is a communication chip or NIC. NIC stands for network interface card.

The master key generation device 200 may include a plurality of processors as an alternative to the processor 201. The plurality of processors share the role of the processor 201. Similarly, the registration key generation device 300 may include a plurality of processors as an alternative to the processor 301. The plurality of processors share the role of the processor 301. Similarly, the user key generation device 400 may include a plurality of processors as an alternative to the processor 401. The plurality of processors share the role of the processor 401. Similarly, the registration request device 500 may include a plurality of processors as an alternative to the processor 501. The plurality of processors share the role of the processor 501. Similarly, the search request device 600 may include a plurality of processors as an alternative to the processor 601. The plurality of processors share the role of the processor 601. Similarly, the data management device 700 may include a plurality of processors as an alternative to the processor 701. The plurality of processors share the role of the processor 701.

### Description of Operation

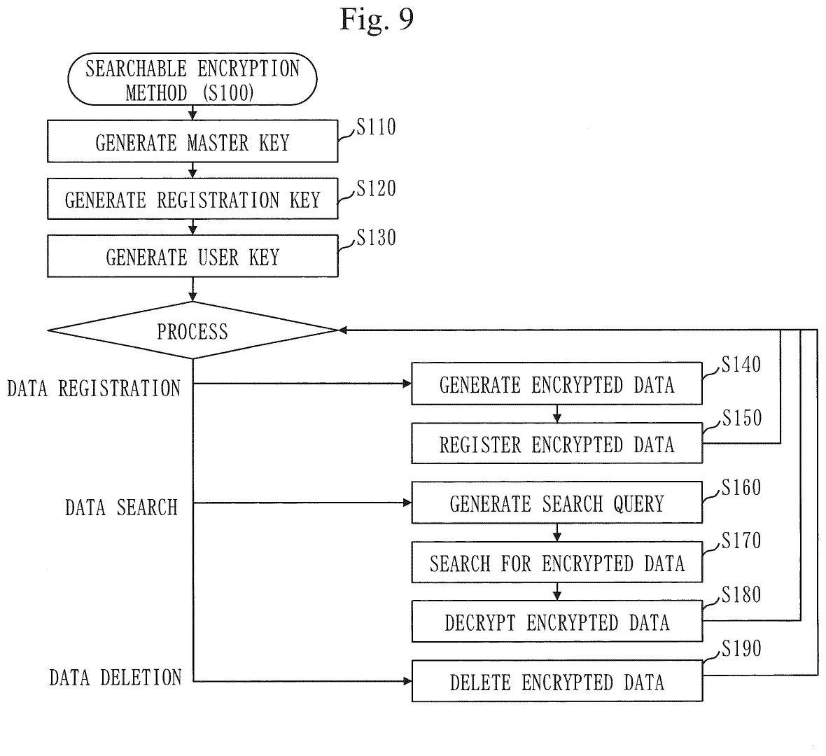

Referring to FIGS. 9 to 20, the operation of the searchable encryption system 100 according to Embodiment 1 will be described.

A procedure for the operation of the searchable encryption system 100 according to Embodiment 1 is equivalent to a searchable encryption method according to Embodiment 1. A program that realizes the operation of the searchable encryption system 100 according to Embodiment 1 is equivalent to a searchable encryption program according to Embodiment 1.

Referring to FIG. 9, overall processing by the searchable encryption system 100 according to Embodiment 1 will be described.

### (Step S110 in FIG. 9: Master Key Generation Process)

The master key generation device 200 generates a master key MK. The master key MK is used to generate a registration key EK.

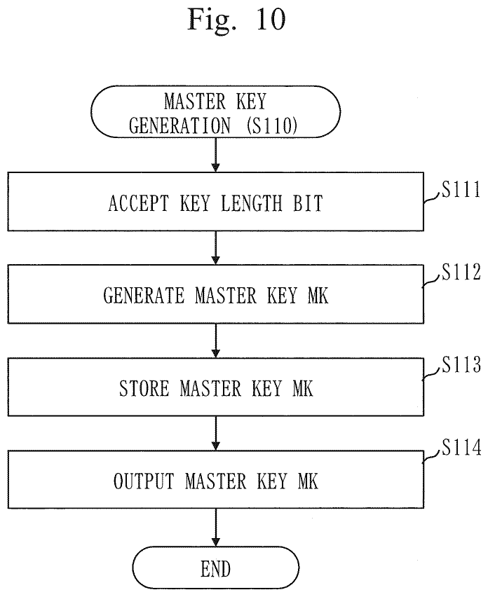

Referring to FIG. 10, the master key generation process according to Embodiment 1 (step S110 in FIG. 9) will be described.

The master key generation process is executed by the master key generation device 200.

A procedure for the operation of the master key generation device 200 according to Embodiment 1 is equivalent to a master key generation method according to Embodiment 1. A program that realizes the operation of the master key generation device 200 according to Embodiment 1 is equivalent to the master key generation program according to Embodiment 1.

### (Step S111 in FIG. 10: Acceptance Process)

The acceptance unit 210 accepts a key length BIT.

Specifically, the acceptance unit 210 accepts, via the input/output interface 204, the key length BIT input to the master key generation device 200. However, the acceptance unit 210 may accept the key length BIT from an application program. The key length BIT is the bit length of the master key MK.

### (Step S112 in FIG. 10: Generation Process)

The generation unit 220 generates the master key MK.

Specifically, the generation unit 220 generates a random bit string with the same length as the key length BIT. The generated bit string is the master key MK. For example, when the key length BIT is 256 bits, the generation unit 220 generates a 256-bit random bit string. This results in the 256-bit master key MK.

### (Step S113 in FIG. 10: Storage Process)

The generation unit 220 stores the master key MK in the storage unit 290.

### (Step S114 in FIG. 10: Output Process)

The output unit 230 outputs the master key MK.

For example, the output unit 230 uses the communication device 205 to transmit the master key MK to the registration key generation device 300.

### (Step S120 in FIG. 9: Registration Key Generation Process)

The registration key generation device 300 uses the master key MK to generate the registration key EK. The registration key EK is used to encrypt data and a keyword related to the data. Additionally, the registration key EK is used to generate a user key UK.

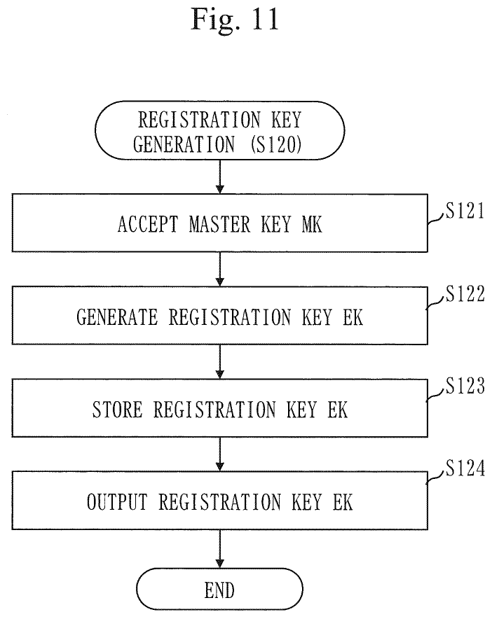

Referring to FIG. 11, the registration key generation process according to Embodiment 1 (step S120 in FIG. 9) will be described.

The registration key generation process is executed by the registration key generation device 300.

A procedure for the operation of the registration key generation device 300 according to Embodiment 1 is equivalent to a registration key generation method according to Embodiment 1. A program that realizes the operation of the registration key generation device 300 according to Embodiment 1 is equivalent to the registration key generation program according to Embodiment 1.

### (Step S121 in FIG. 11: Acceptance Process)

The acceptance unit 310 accepts the master key MK.

For example, the acceptance unit 310 uses the communication device 305 to receive the master key MK from the master key generation device 200. However, the acceptance unit 310 may accept, via the input/output interface 304, the master key MK input to the registration key generation device 300.

### (Step S122 in FIG. 11: Generation Process)

The generation unit 320 uses the master key MK to generate the registration key EK.

Specifically, the generation unit 320 executes a function F_EK using the master key MK as input. The value obtained by executing the function F_EK is the registration key.

An example of the function F_EK is a one-way function. A one-way function is a function where it is difficult to compute an input value from an output value of the function. For example, a cryptographic hash function like SHA256 or a function of an encryption scheme such as AES is used as the function F_EK. AES stands for Advanced Encryption Standard.

The registration key EK can be expressed as follows.

EK=F_EK(MK)

If the registration key EK that has already been generated needs to be updated to a new registration key EK′ due to compromise of the registration key EK or the function F_EK, the new registration key EK′ may be generated by adding a value such as a generation number i to the input of the function F_EK. For example, the generation number i is information such as a serial number or date and time. The generation number i may be accepted by the acceptance unit 310 along with the master key MK.

The registration key EK′ generated taking into account the generation number i can be expressed as follows.

EK′=F_EK(MK∥i)

For data x and data y, “x∥y” represents the concatenation of x and y.

### (Step S123 in FIG. 11: Storage Process)

The generation unit 320 stores the registration key EK in the storage unit 390.

### (Step S124 in FIG. 11: Output Process)

The output unit 330 outputs the registration key EK.

For example, the output unit 330 uses the communication device 305 to transmit the registration key EK to both the user key generation device 400 and the registration request device 500.

### (Step S130 in FIG. 9: User Key Generation Process)

The user key generation device 400 uses the registration key EK to generate the user key UK. The user key UK is used to encrypt a search keyword. Additionally, the user key UK is used to decrypt a ciphertext and restore original data.

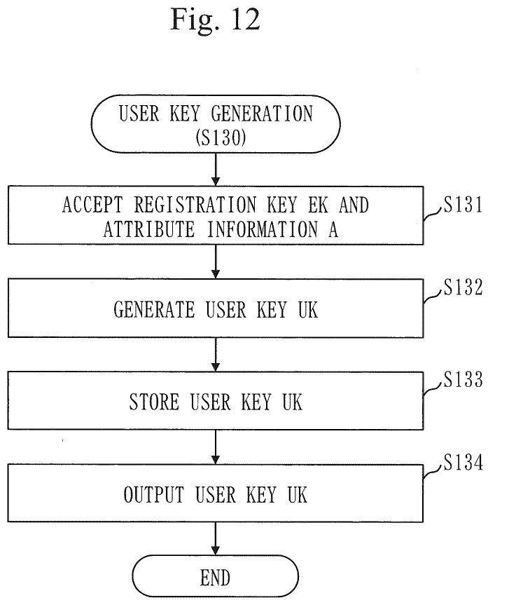

Referring to FIG. 12, the user key generation process (step S130 in FIG. 9) according to Embodiment 1 will be described.

The user key generation process is executed by the user key generation device 400.

A procedure for the operation of the user key generation device 400 according to Embodiment 1 is equivalent to a user key generation method according to Embodiment 1. A program that realizes the operation of the user key generation device 400 according to Embodiment 1 is equivalent to the user key generation program according to Embodiment 1.

### (Step S131 in FIG. 12: Acceptance Process)

The acceptance unit 410 accepts the registration key EK. Then, the acceptance unit 410 stores the registration key EK in the storage unit 490.

For example, the acceptance unit 410 uses the communication device 405 to receive the registration key EK from the registration key generation device 300. However, the acceptance unit 410 may accept, via the input/output interface 404, the registration key EK input to the user key generation device 400.

If the registration key EK is already stored in the storage unit 490, receiving the registration key EK is unnecessary. However, if there is an update to the registration key EK, a new registration key EK is added.

Additionally, the acceptance unit 410 accepts attribute information A.

Specifically, the acceptance unit 410 accepts, via the input/output interface 404, the attribute information A input to the user key generation device 400. However, the acceptance unit 410 may accept the attribute information A from an application program.

The attribute information A is attribute information of searchers. The attribute information A is related to control of decryption and search privileges. A searcher is a user who performs searches. That is, a searcher is a user of the search request device 600. The attributes of users form a hierarchy. Attribute information indicates the attribute values of users in each layer. That is, the attribute information A indicates the attribute values of searchers in each layer.

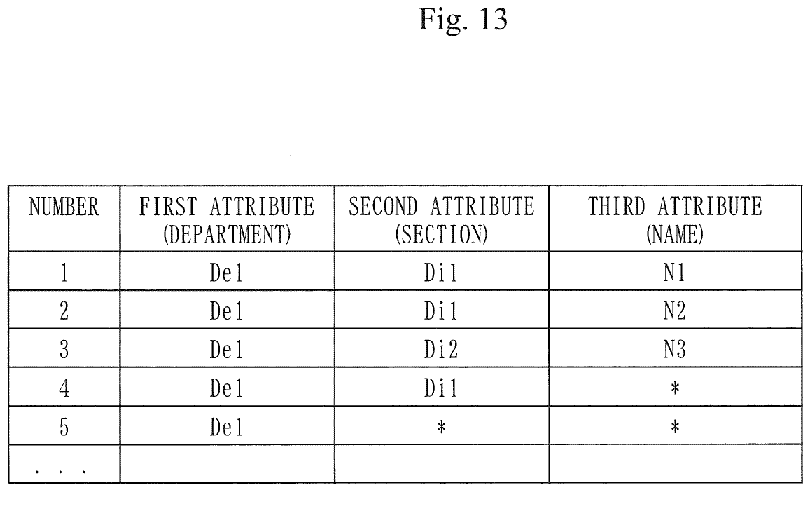

Referring to FIG. 13, an example of attribute information according to Embodiment 1 will be described.

The attributes of users form a hierarchy. In FIG. 13, the attributes of users form three layers. An attribute in the first layer (first attribute) indicates a department. An attribute in the second layer (second attribute) indicates a section. An attribute in the third layer (third attribute) indicates a name.

In Embodiment 1, a wildcard “*” can be used for the attributes of each layer. The wildcard “*” represents any character string. In other words, it is a special symbol that matches any character string.

The attribute information of number 1 is attribute information with a name N1. N1 belongs to a Di1 section of a De1 department.

The attribute information of number 2 is attribute information with a name N2. N2 belongs to the Di1 section of the De1 department.

The attribute information of number 3 is attribute information with a name N3. N3 belongs to a Di2 section of the De1 department.

The attribute information of number 4 is attribute information of a person who belongs to the Di1 section of the De1 department and whose name is a wildcard “*”. This attribute information represents all persons belonging to the Di1 section of the De1 department because the name is a wildcard “*”. That is, this attribute information includes the first attribute information of N1 and the second attribute information of N2. In other words, this attribute information includes the attribute information related to N1 and the attribute information related to N2, and is attribute information located at a higher level in the hierarchy than those pieces of attribute information.

For example, the head of the Di1 section of the De1 department, who is the supervisor of N1 and N2, corresponds to this attribute information.

The attribute information of number 5 is attribute information of a person who belongs to the De1 department and whose section name and name are wildcards “*”. This attribute information represents all persons belonging to the De1 department. That is, this attribute information includes the attribute information of number 1 of N1, the attribute information of number 2 of N2, the attribute information of number 3 of N3, and also the attribute information of number 4 of the head of the Di1 section. In other words, this attribute information includes the attribute information related to N1, the attribute information related to N2, the attribute information related to N3, and also the attribute information of number 4 of the head of the Di1 section, and is attribute information located at a higher level in the hierarchy than those pieces of attribute information.

For example, the head of the De1 department corresponds to this attribute information.

In Embodiment 1, the attributes of users form L layers, and attribute information has L attribute values. L is an integer of 1 or more. That is, one attribute value is assigned to each layer.

Furthermore, in Embodiment 1, if a wildcard “*” is set for the l-th attribute value representing an attribute of the l-th layer, wildcards “*” are set for all of the l+1-th and subsequent attribute values. Note that l is an integer from 1 to L.

In this case, the attribute information A can be expressed as follows.

A=(A_1, . . . , A_L)

A_1, . . . , A_L are attribute values. If A_1 is a wildcard “*”, A_1+1 to A_L are all wildcards “*”.

### (Step S132 in FIG. 12: Generation Process)

The generation unit 420 uses the registration key EK and the attribute information A to generate the user key UK. Specifically, the generation unit 420 calculates the user key UK as follows.

First, the generation unit 420 concatenates all of A_1 to A_L for the attribute information A=(A_1, . . . , A_L). The value represented by the resulting bit string is called a concatenated value A&. That is, the concatenated value A& can be expressed as follows.

A&=A_1∥ . . . ∥ A_L

Next, the generation unit 420 executes a function F_UK using the registration key EK and the concatenated value A& as input. The resulting value is called a user key element uk. The function F_UK is a one-way function such as a hash function or a common-key encryption scheme. The user key element uk can be expressed as follows.

uk=F_UK(EK∥A&)

=F_UK(EK∥A_1∥ . . . ∥A_L)

Next, the generation unit 420 executes a function F_UKA using the registration key EK and the concatenated value A& as input. The resulting value is called a user key attribute uka. The function F_UKA is a one-way function such as a hash function or a common-key encryption scheme. Note that the function F_UKA is not the same function as the function F_UK. If the function F_UK is used as the function F_UKA, it is necessary to concatenate a constant value such as 0 to the input values of the function F_UK to generate the user key attribute uka that is different from the user key element uk. The user key attribute uka can be expressed as follows.

uka=F_UKA(EK∥A_1∥ . . . ∥A_L)

=F_UKA(EK∥A&)

Then, the generation unit 420 sets a pair of the user key element uk and the user key attribute uka as the user key UK. The user key UK can be expressed as follows.

UK=(uk, uka)

### (Step S133 in FIG. 12: Storage Process)

The generation unit 420 stores the user key UK in the storage unit 490.

### (Step S134 in FIG. 12: Output Process)

The output unit 430 outputs the user key UK.

For example, the output unit 430 uses the communication device 405 to transmit the user key UK to the search request device 600.

After the user key generation process (step S130 in FIG. 9), the operation shifts to the step corresponding to the execution content. Specifically, if data registration is to be performed, the operation shifts to the process of step S140. If data search is to be performed, the operation shifts to the process of step S160. If data deletion is to be performed, the operation shifts to the process of step S190.

### (Step S140 in FIG. 9: Registration Request Process)

The registration request device 500 uses the registration key EK to generate encrypted data. The encrypted data includes a ciphertext CT and an encrypted tag set ETS. The encrypted tag set ETS includes one or more encrypted tags ET.

The ciphertext CT is used to restore plaintext data D included in the ciphertext CT using the user key UK.

A keyword is set in the encrypted tag ET. The encrypted tag ET is used to determine whether a match occurs between the set keyword and a search keyword included in a search query. The search query is generated by encrypting the search keyword with the user key UK. Whether a match occurs is determined while maintaining the encrypted state.

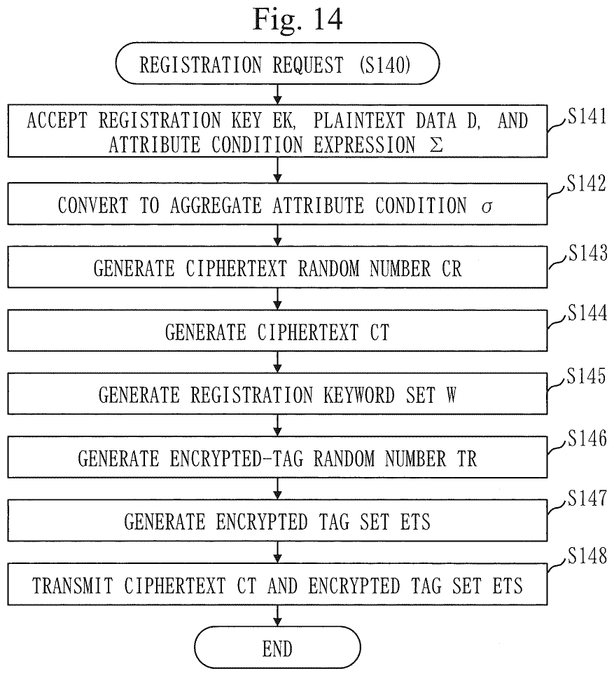

Referring to FIG. 14, the registration request process (step S140 in FIG. 9) according to Embodiment 1 will be described.

The registration request process is executed by the registration request device 500.

A procedure for the operation of the registration request device 500 according to Embodiment 1 is equivalent to a registration request method according to Embodiment 1. A program that realizes the operation of the registration request device 500 according to Embodiment 1 is equivalent to the registration request program according to Embodiment 1.

### (Step S141 in FIG. 14: Acceptance Process)

The acceptance unit 510 accepts the registration key EK. Then, the acceptance unit 510 stores the registration key EK in the storage unit 590.

For example, the acceptance unit 510 uses the communication device 505 to receive the registration key EK from the registration key generation device 300. However, the acceptance unit 510 may accept, via the input/output interface 504, the registration key EK input to the registration request device 500.

If the registration key EK is already stored in the storage unit 590, receiving the registration key EK is unnecessary. However, if there is an update to the registration key EK, a new registration key EK is added.

The acceptance unit 510 also accepts the plaintext data D and an attribute condition expression Σ.

Specifically, the acceptance unit 510 accepts, via the input/output interface 504, the plaintext data D and the attribute condition expression Σ that are input to the registration request device 500. However, the acceptance unit 510 may accept the plaintext data D and the attribute condition expression Σ from an application program.

The plaintext data D is data that has not been encrypted. The plaintext data D includes a unique identifier ID(D) as metadata indicating it.

The attribute condition expression Σ is information related to attributes where each attribute condition X is connected by a logical operator OR. The attribute condition X is information that specifies attribute information of a searcher who is allowed to decrypt a ciphertext or perform a secret search for an encrypted tag. The attribute condition X has a structure similar to the attribute information A used to generate the user key UK. That is, the attribute condition X is information related to control of privileges for decryption and searches, and can be expressed as follows.

X=(X_1, . . . , X_L)

For example, it is assumed that the attribute information of number 1 (De1, Di1, N1), which is the attribute information related to N1, indicated in FIG. 13 is specified as the attribute condition X. That is, it is assumed that X=(De1, Di1, N1) is specified.

In this case, a searcher who owns a user key UK generated from one of the attribute information of number 1 related to N and the attribute information of number 4 or 5 corresponding to the supervisor of N1 can decrypt a ciphertext and search for an encrypted tag for which the attribute condition X is specified.

Furthermore, the attribute condition expression Σ is data composed of a plurality of attribute conditions X. That is, it can be expressed using M or more attribute conditions X as indicated below. M is an integer of 1 or more.

Σ=(X1, . . . , XM)

For example, it is assumed that the attribute condition expression Σ is composed of an attribute condition X1 and an attribute condition X2. That is, it is assumed that M=2. It is assumed that the attribute information of number 1 (De1, Di1, N1), which is the attribute information related to N1, indicated in FIG. 13 is specified as the attribute condition X1, and the attribute information of number 2 (De1, Di1, N2), which is the attribute information related to N2, is specified as the attribute condition X2. That is, it is assumed that X1=(De1, Di1, N1) and X2=(De1, Di1, N2), and Σ=(X1, X2).

In this case, a searcher who owns a user key UK generated from one of the attribute information of number 1 related to N1, the attribute information of number 2 related to N2, and the attribute information of number 4 or 5 corresponding to the supervisor of N1 and N2 can decrypt a ciphertext and search for an encrypted tag for which the attribute condition expression Σ is specified.

That is, using the logical operator OR, the attribute condition expression Σ=(X1, . . . , XM) can be regarded as a logical expression as follows.

Σ=X1 OR. . . . OR XM

### (Step S142 in FIG. 14: Aggregate Condition Generation Process)

The aggregate condition generation unit 521 generates an aggregate attribute condition σ from the attribute condition expression Σ. The aggregate attribute condition σ for the attribute condition expression Σ includes a plurality of attribute conditions Y obtained by adding one or more higher-level attribute conditions X′ including at least one of the plurality of attribute conditions X included in the attribute condition expression Σ to the plurality of attribute conditions X. That is, the attribute conditions Y include the plurality of attribute conditions X and one or more higher-level attribute conditions X′.

That is, the aggregate attribute condition σ is information that specifies the attribute information of searchers who are allowed to decrypt a ciphertext or search for an encrypted tag, and is a condition indicating the same searchers specified by the attribute condition expression Σ. The aggregate attribute condition σ can be expressed using J attribute conditions Y as indicated below. Note that J is an integer of 1 or more.

Σ=(Y1, . . . , YJ)

Note that higher levels in the hierarchy do not overlap. For example, any attribute information may include attribute information where all are wildcards “*” (*, . . . , *) as a higher level in the hierarchy. However, the aggregate attribute condition σ is not to include a plurality of attribute conditions X′ that redundantly indicate the attribute information (*, . . . , *). In other words, all attribute conditions Y1 to YJ are different attribute conditions.

For example, it is assumed that the attribute condition expression Σ is composed of attribute conditions X1, X2, and X3. That is, it is assumed that J=3. Using the attribute information indicated in FIG. 13, it is assumed that the attribute condition X1 is (De1, Di1, N1), the attribute condition X2 is (De1, Di1, N2), and the attribute condition X3 is (De1, Di2, N3).

In this case, the attribute conditions including a higher level or higher levels in the hierarchy that match the attribute condition X1 are as follows.
(De1, Di1, *)
(De1, *, *)
(*, *, *)

The attribute conditions including a higher level or higher levels in the hierarchy that match the attribute condition X2 are as follows.
(De1, Di1, *)
(De1, *, *)
(*, *, *)

The attribute conditions including a higher level or higher levels in the hierarchy that match the attribute condition X3 are as follows.
(De1, Di2, *)
(De1, *, *)
(*, *, *)

Therefore, the aggregate attribute condition σ in this case is composed of the following seven attribute conditions Yj. Note that j is an integer from 1 to 7.
Y1=(De1, Di1, N1)
Y2=(De1, Di1, N2)
Y3=(De1, Di1, *)
Y4=(De1, Di3, N3)
Y5=(De1, Di2, *)
Y6=(De1, *, *)
Y7=(*, *, *)

### (Step S143 in FIG. 14: Ciphertext Random Number Generation Process)

The random number generation unit 522 generates a random number s and a random number r. The random number generation unit 522 sets these two random numbers as a ciphertext random number CR. That is, the ciphertext random number CR can be expressed as follows.

CR=(s, r)

### (Step S144 in FIG. 14: Ciphertext Generation Process)

The ciphertext generation unit 523 uses the registration key EK, the plaintext data D, the aggregate attribute condition σ, and the ciphertext random number CR to generate the ciphertext CT.

The ciphertext CT includes J ciphertext elements CT_j, a ciphertext random number s, a ciphertext verification value CTV, and a ciphertext payload CTP. The j of the ciphertext element CT_j is an integer from 1 to J, and J is the number of attribute conditions Y included in the aggregate attribute condition σ. The ciphertext random number s is the random number s included in the ciphertext random number CR. The ciphertext CT also includes the unique identifier ID(D) of the plaintext data as metadata. This unique identifier ID(D) may be encrypted.

The ciphertext generation unit 523 calculates the ciphertext element C_j for each integer j of j=1, . . . , J as follows.

First, the ciphertext generation unit 523 concatenates the registration key EK and Yj included in the aggregate attribute condition σ. The value represented by the resulting bit string is called a concatenated value Yj′. Next, the ciphertext generation unit 523 executes the function F_UK using the concatenated value Yj′ as input. The resulting value is called a function value Yj″. Next, the ciphertext generation unit 523 concatenates the function value Yj″ and the ciphertext random number s. The value represented by the resulting bit string is called a concatenated value Yjs′. Next, the ciphertext generation unit 523 executes a function F_CT using the concatenated value Yjs′ as input. The resulting value is called a function value Yjs″. Then, the ciphertext generation unit 523 calculates the exclusive OR of the function value Yjs″ and the random number r. The resulting value is the ciphertext element C_j.

The function F_UK is the one-way function used in the process of step S132 in FIG. 12. The function F_CT is a one-way function such as a hash function or a common-key encryption scheme.

In the ciphertext element C_j, the attribute condition Yj included in the aggregate attribute condition σ is set as a decryption condition. As a result, the decryption condition set in the ciphertext CT is such that the attribute conditions Yj included in the aggregate attribute condition σ are connected by the logical operator OR.

The ciphertext generation unit 523 calculates the ciphertext verification value CTV as follows.

The ciphertext generation unit 523 executes a function F_CTV using the random number r as input. The resulting value is the ciphertext verification value CTV. The function F_CTV is a one-way function such as a hash function or a common-key encryption scheme.

The ciphertext generation unit 523 calculates the ciphertext payload CTP as follows.

The ciphertext generation unit 523 executes a function ENC on the plaintext data D using the random number r as a key. The resulting value is the ciphertext payload CTP. The function ENC is a common-key encryption scheme, such as AES, which can restore original plaintext data from encrypted data.

A function to restore the original plaintext data from the output value of the function ENC and the key used in its calculation is called a function DEC. That is, the function DEC is DEC(KEY, ENC(KEY, D))=D for a certain key KEY.

The ciphertext CT can be expressed as follows. Note that “+” means an exclusive OR (XOR) in Embodiment 1.

$$CT = ( CT\_ 1 , … , CT\_J , s , CTV , CTP )$$

$$CT\_j = F\_CT ( F\_UK ( EK ‖ Yj ) ‖ s ) + r$$

$$CTV = F\_CTV ( r )$$

$$CTP = F\_CTP ( r , D )$$

### (Step S145 in FIG. 14: Keyword Generation Process)

The keyword generation unit 524 generates a keyword group related to the plaintext data D. The keyword group is composed of one or more keywords.

Specifically, the keyword generation unit 524 generates the keyword group from the plaintext data D by performing morphological analysis, natural language processing, or the like on the plaintext data D. However, the keyword generation unit 524 may accept, via the input/output interface 504, the keyword group input to the registration request device 500. The keyword generation unit 524 may accept the keyword group from an application program.

The generated keyword group is called a registration keyword set W.

In Embodiment 1, it is assumed that the registration keyword set W is composed of I registration keywords. I is an integer of 1 or more. The registration keyword set W can be expressed as follows.

W=(W_1, . . . , W_I)

### (Step S146 in FIG. 14: Tag Random Number Generation Process)

The random number generation unit 522 generates a random number S and a random number R. The random number generation unit 522 sets these two random numbers as an encrypted-tag random number TR. That is, the encrypted-tag random number TR can be expressed as follows.

TR=(S, R)

### (Step S147 in FIG. 14: Encrypted Tag Generation Process)

The encrypted tag generation unit 525 uses the registration key EK, the registration keyword set W, the aggregate attribute condition σ, and the encrypted-tag random number TR to generate the encrypted tag set ETS.

The encrypted tag set ETS includes I encrypted tags ETi. The i of the encrypted tag ETi is an integer from 1 to I, and I is the number of keywords included in the registration keyword set W.

The encrypted tag ETi includes J tag elements ETi_j, an encrypted-tag random number S, and an encrypted-tag verification value ETV. The j of the tag element ETi_j is an integer from 1 to J, and J is the number of attribute conditions Y included in the aggregate attribute condition σ. The encrypted-tag random number S is the random number S included in the encrypted-tag random number TR.

The encrypted tag generation unit 525 calculates the tag element ETi_j for each integer i and integer j, where i=1, . . . , I and j=1, . . . , J, as follows.

First, the encrypted tag generation unit 525 concatenates the registration key EK and Yj included in the aggregate attribute condition σ. The value represented by the resulting bit string is called a concatenated value Yj\hat{ }. Next, the encrypted tag generation unit 525 executes the function F_UK using the concatenated value Yj\hat{ } as input. The resulting value is called a function value Yj\hat{ }\hat{ }. Next, the encrypted tag generation unit 525 concatenates the function value Yj\hat{ }\hat{ } and the keyword W_i. The value represented by the resulting bit string is called a concatenated value YjW\hat{ }. Next, the encrypted tag generation unit 525 executes a function F_ET1 using the concatenated value YjW\hat{ } as input. The resulting value is called a function value YjW\hat{ }\hat{ }. Next, the encrypted tag generation unit 525 concatenates the function value YjW\hat{ }\hat{ } and the encrypted-tag random number S. The value represented by the resulting bit string is called a concatenated value YjWS\hat{ }. Next, the encrypted tag generation unit 525 executes a function F_ET2 using the concatenated value YjWS\hat{ } as input. The resulting value is called a function value YjWS\hat{ }\hat{ }. Then, the encrypted tag generation unit 525 calculates the exclusive OR of the function value YjWS\hat{ }\hat{ } and the random number R. The resulting value is the tag element ETi_j.

The function F_UK is the one-way function used in the process of step S132 in FIG. 12 and the process of step S144 in FIG. 14. Each of the functions F_ET1 and F_ET2 is a one-way function such as a hash function or a common-key encryption scheme.

In the tag element ETi_j, Yj included in the aggregate attribute condition σ is set as a search condition. As a result, the search condition set in the encrypted tag ETi is such that the attribute conditions Yj included in the aggregate attribute condition σ are connected by the logical operator OR.

The encrypted tag generation unit 525 calculates the encrypted tag verification value ETV as follows.

The encrypted tag generation unit 525 executes a function F_ETV using the random number R as input. The resulting value is the encrypted tag verification value ETV. The function F_ETV is a one-way function such as a hash function or a common-key encryption scheme.

The encrypted tag set ETS can be expressed as follows.

$$ETS = ( ET 1 , … , ETK , S , ETV )$$

$$ETi = ( ETi\_ 1 , … , ETi\_K )$$

$$ETi\_j = F\_ET2 ( F\_ET 1 ( F\_UK ( EK ‖ Yj ) ‖ W\_i ) ‖ S ) + R$$

$$ETV = F\_ETV ( R )$$

### (Step S148 in FIG. 14: Registration Request Process)

The request unit 530 requests the data management device 700 to register encrypted data that is a combination of the ciphertext CT and the encrypted tag set ETS.

### (Step S150 in FIG. 9: Registration Operation Process)

The data management device 700 registers the encrypted data. The encrypted data includes the ciphertext CT and the encrypted tag set ETS. The encrypted tag set ETS includes one or more encrypted tags ET.

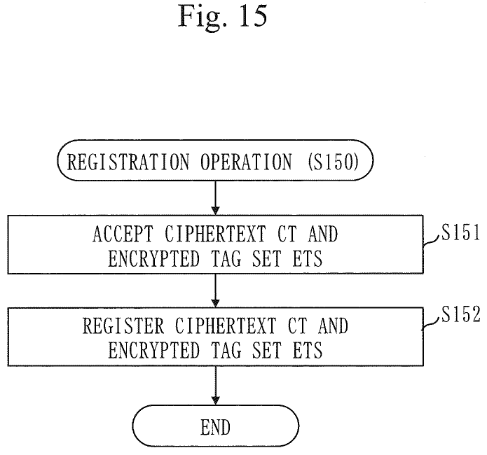

Referring to FIG. 15, the registration operation process according to Embodiment 1 (step S150 in FIG. 9) will be described.

The registration operation process is executed by the data management device 700.

A procedure for the operation of the data management device 700 according to Embodiment 1 is equivalent to a data management method according to Embodiment 1. A program that realizes the operation of the data management device 700 according to Embodiment 1 is equivalent to the data management program according to Embodiment 1.

### (Step S151 in FIG. 15: Acceptance Process)

The acceptance unit 710 accepts the ciphertext CT and the encrypted tag set ETS.

For example, the acceptance unit 710 uses the communication device 705 to receive the ciphertext CT and the encrypted tag set ETS from the registration request device 500. However, the acceptance unit 710 may accept, via the input/output interface 704, the ciphertext CT and the encrypted tag set ETS that are input to the data management device 700.

### (Step S152 in FIG. 15: Registration Process)

The registration unit 720 stores the ciphertext CT and the encrypted tag set ETS in the storage unit 790.

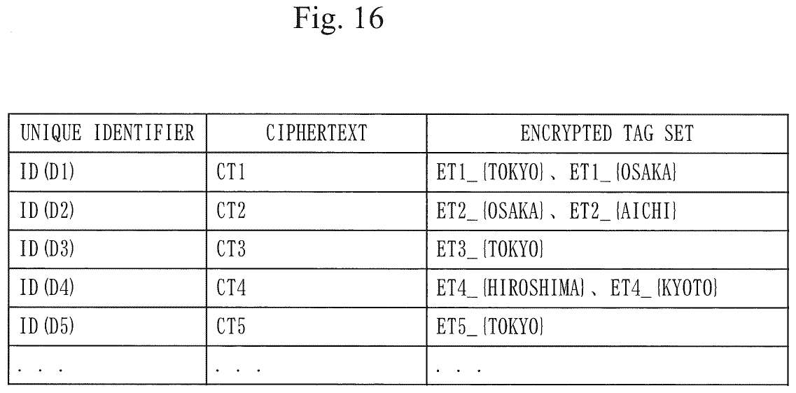

As indicated in FIG. 16, the storage unit 790 stores the unique identifier ID(D), the ciphertext CT, and the encrypted tag set ETS in a state where they are associated with one another.

### (Step S160 in FIG. 9: Search Request Process)

The search request device 600 uses the user key UK to generate a search query SQ. The search query SQ is used to perform a secret search for an encrypted tag ET.

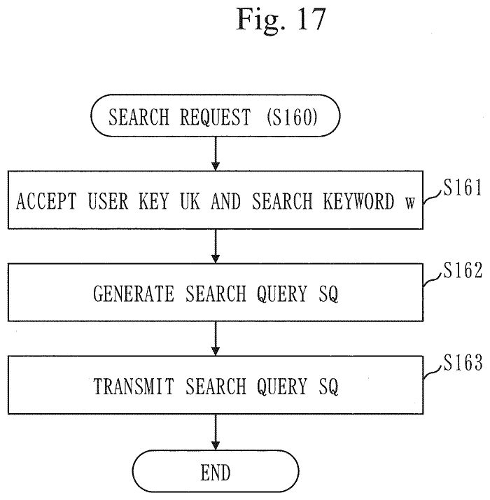

Referring to FIG. 17, the search request process according to Embodiment 1 (Step S150 in FIG. 9) will be described.

The search request process is executed by the search request device 600.

A procedure for the operation of the search request device 600 according to Embodiment 1 is equivalent to a search request method according to Embodiment 1. A program that realizes the operation of the search request device 600 according to Embodiment 1 is equivalent to the search request program according to Embodiment 1.

### (Step S161 in FIG. 17: Acceptance Process)

The acceptance unit 610 accepts the user key UK. Then, the acceptance unit 610 stores the user key UK in the storage unit 690.

For example, the acceptance unit 610 uses the communication device 605 to receive the user key UK from the user key generation device 400. However, the acceptance unit 610 may accept, via the input/output interface 604, the user key UK input to the search request device 600.

If the user key UK is already stored in the storage unit 690, receiving the user key UK is unnecessary. However, if there is an update to the user key UK, a new user key UK is added.

Additionally, the acceptance unit 610 accepts a search keyword w.

Specifically, the acceptance unit 610 accepts, via the input/output interface 604, the search keyword w input to the search request device 600. However, the acceptance unit 610 may accept the search keyword w from an application program.

### (Step S162 in FIG. 17: Generation Process)

The generation unit 620 uses the user key UK and the search keyword w to generate a search query SQ. Specifically, the generation unit 620 calculates the search query SQ as follows.

First, the generation unit 620 extracts the user key element uk from the user key UK. Next, the generation unit 620 concatenates the user key element uk and the search keyword w. The value represented by the resulting bit string is called a concatenated value UKw\hat{ }. Then, the generation unit 620 executes the function F_ET1 using the concatenated value UKw\hat{ } as input. The resulting value is the search query SQ.

The function F_ET1 is the one-way function used in the process of step S147 in FIG. 14.

The search query SQ can be expressed as follows.

SQ=F_ET1(uk∥w)

### (Step S163 in FIG. 17: Request Process)

The request unit 630 uses the communication device 605 to transmit the search query SQ to the data management device 700.

### (Step S170 in FIG. 9: Search Operation Process)

The data management device 700 searches for encrypted data. The encrypted data includes a ciphertext CT and an encrypted tag set ETS. The encrypted tag set ETS includes one or more encrypted tags ET.

The data management device 700 performs a secret search on each encrypted tag ET using the search query SQ. As a result, the data management device 700 determines whether the keyword included in each encrypted tag ET matches the search keyword included in the search query SQ. If they match, the data management device 700 extracts the ciphertext CT stored in association with the encrypted tag ET.

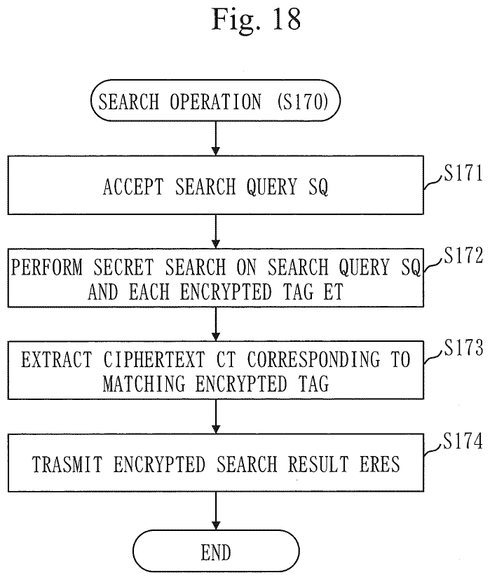

Referring to FIG. 18, the search operation process according to Embodiment 1 (step S170 in FIG. 9) will be described.

The search operation process is executed by the data management device 700.

### (Step S171 in FIG. 18: Acceptance Process)

The acceptance unit 710 accepts the search query SQ.

For example, the acceptance unit 710 uses the communication device 705 to receive the search query SQ from the search request device 600. However, the acceptance unit 610 may accept, via the input/output interface 704, the search query SQ input to the data management device 700.

### (Step S172 in FIG. 18: Search Process)

The search unit 730 uses the search query SQ to perform a secret search on each of J tag elements ETi_j of each of I encrypted tags ETi included in the encrypted tag set ETS. As a result, the search unit 730 selects the encrypted tag set ETS that matches the search query SQ.

The i of the encrypted tag ETi is an integer between 1 and I, and I is the number of encrypted tags ETi included in the encrypted tag set ETS. The j of the tag element ETi_j is an integer between 1 and J, and J is the number of tag elements ETi_j included in the encrypted tag ETi.

Specifically, the search unit 730 processes each tag element ETi_j of each encrypted tag ETi in the encrypted tag set ETS as follows.

First, the search unit 730 concatenates the search query SQ and the encrypted-tag random number S included in the encrypted tag set ETS. The value represented by the resulting bit string is called a concatenated value SQ\hat{ }. Next, the search unit 730 executes the function F_ET2 using the concatenated value SQ\hat{ } as input. The resulting value is called a function value SQ\hat{ }\hat{ }. Next, the search unit 730 calculates the exclusive OR of the function value SQ\hat{ }\hat{ } and the encrypted tag ETi_j. The resulting value is called a calculated value Rij. Next, the search unit 730 executes the function F_ETV using the calculated value Rij as input. The resulting value is called a function value Vij. Then, the search unit 730 checks whether the function value Vij matches the encrypted-tag verification value ETV included in the encrypted tag set ETS.

If the values match, the unique identifier ID corresponding to that encrypted tag ETi_j is extracted.

The functions F_ET2 and F_ETV are the one-way functions used in step S147 in FIG. 14.

The function value SQ\hat{ }\hat{ } and the calculated value Rij obtained by the above processing can be expressed as follows.

$$\begin{matrix}SQ \hat{} \hat{}= F\_ET2 ( SQ ‖ S ) \\ = F\_ET2 ( F\_ET1 ( F\_UK ( EK \vert \vert A \& ) ‖ w ) ‖ S )\end{matrix}$$

$$\begin{matrix}Rij = SQ \hat{} \hat{} + ETi\_j \\ = F\_ET2 ( F\_ET1 ( F\_UK ( EK \vert \vert A \& ) ‖ w ) ‖ S ) \\ + F\_ET2 ( F\_ET1 ( F\_UK ( EK \vert \vert Yj ) ‖ W\_i ) ‖ S ) \\ + R\end{matrix}$$

If “A&=Yj” and “w=W_i”, that is, if “the attribute information A included in the user key UK is equal to the attribute condition Yj included in the encrypted tag ETi” and “the search keyword w is equal to the registration keyword W_i”, then “Rij=R”.

Therefore, in this case, “Vij=F_ETV(Rij)=F_ETV(R)=ETV”.

A set of extracted unique identifiers ID is called a corresponding unique identifier set IDS.

### (Step S173 in FIG. 18: Ciphertext Extraction Process)

The search unit 730 extracts the ciphertext CT corresponding to each unique identifier ID included in the corresponding unique identifier set IDS from the storage unit 790. A set of extracted ciphertexts CT is called an encrypted search result ERES.

If the corresponding unique identifier set IDS is an empty set, this step is omitted.

### (Step S174 in FIG. 18: Output Process)

The output unit 740 transmits the encrypted search result ERES to the search request device 600.

### (Step S180 in FIG. 9: Decryption Operation Process)

The search request device 600 uses the user key UK to decrypt the encrypted data. The encrypted data is each ciphertext CT included in the encrypted search result ERES.

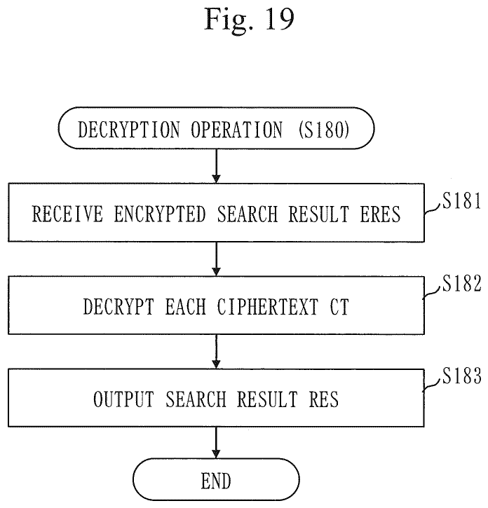

Referring to FIG. 19, the decryption operation process according to Embodiment 1 (step S180 in FIG. 9) will be described.

The decryption operation process is executed by the search request device 600.

### (Step S181 in FIG. 19: Acceptance Process)

The acceptance unit 610 accepts the encrypted search result ERES.

For example, the acceptance unit 610 uses the communication device 605 to receive the encrypted search result ERES from the data management device 700. However, the acceptance unit 610 may accept, via the input/output interface 604, the encrypted search result ERES input to the search request device 600.

### (Step S182 in FIG. 19: Decryption Process)

The decryption unit 640 uses the user key UK to decrypt each ciphertext CT included in the encrypted search result ERES so as to generate plaintext data D.

If the encrypted search result ERES is an empty set, this step is omitted.

Specifically, the decryption unit 640 sets each ciphertext CT included in the encrypted search result ERES as a target ciphertext CT. The decryption unit 640 performs the following processing on the ciphertext element CT_j in the target ciphertext CT for each integer j of j=1, . . . , J to perform decryption. Note that j is an integer between 1 and J, and J is the number of ciphertext elements CT_j included in the ciphertext CT.

First, the decryption unit 640 concatenates the user key element uk included in the user key UK and the ciphertext random number s included in the ciphertext CT. The value represented by the resulting bit string is called a concatenated value uk′\hat{ }. Next, the decryption unit 640 executes the function F_CT using the concatenated value uk′\hat{ } as input. The resulting value is called a function value uk″. Next, the decryption unit 640 calculates the exclusive OR of the function value uk″ and the ciphertext element CT_j. The resulting value is called a calculated value rj. Next, the decryption unit 640 executes the function F_CTV using the calculated value rj as input. The resulting value is called a function value vj. Next, the decryption unit 640 checks whether the function value vj matches the ciphertext verification value CTV included in the ciphertext CT.

Then, if the function value vj matches the ciphertext verification value CTV, the decryption unit 640 executes the function DEC on the ciphertext payload CTP using the calculated value rj as a key. The resulting value is the plaintext data D.

The functions F_CT and F_CTV are the one-way functions used in step S144 in FIG. 14.

The function value uk″ and the calculated value rj obtained by the above processing can be expressed as follows.

$$\begin{matrix}{uk}^{′′} = F\_CT ( uk ‖ s ) \\ = F\_CT ( F\_UK ( EK ‖ A \& ) ‖ s )\end{matrix}$$

$$\begin{matrix}rj = {uk}^{′′} + CT\_j \\ = F\_CT ( F\_UK ( EK ‖ A \& ) ‖ s ) \\ + F\_CT ( F\_UK ( EK ‖ Yj ) ‖ s ) + r\end{matrix}$$

If “A&=Yj”, that is, if “the attribute information A included in the user key UK is equal to the attribute condition Yj included in the ciphertext CT”, then “rj=r”. Therefore, in this case, “vj=F_CTV(rj)=F_CTV(r)=CTV”.

A set of pieces of plaintext data D obtained here is called a search result RES.

### (Step S183 in FIG. 19: Output Process)

The output unit 650 outputs all the pieces of plaintext data D included in the search result RES.

Specifically, the output unit 650 displays all the pieces of plaintext data D on a display via the input/output interface 604. If the search result RES is an empty set, that is, if there is no encrypted tag ET found as a hit in the search, the output unit 650 displays a message indicating that there is no plaintext data D found as a hit in the search.

### (Step S190 in FIG. 9: Deletion Operation Process)

The data management device 700 deletes encrypted data. The encrypted data is composed of a ciphertext CT and an encrypted tag set ETS corresponding to the ciphertext CT.

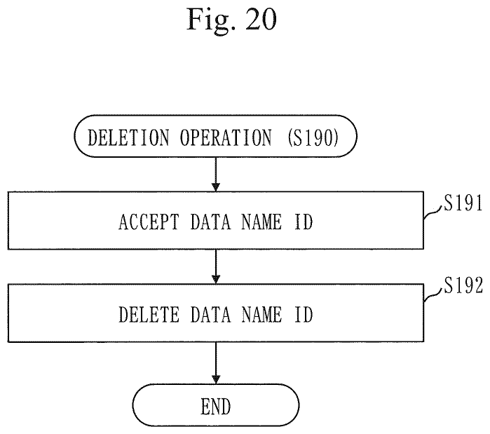

Referring to FIG. 20, the deletion operation process according to Embodiment 1 (step S190 in FIG. 9) will be described.

The deletion operation process is executed by the data management device 700.

### (Step S191 in FIG. 20: Acceptance Process)

The acceptance unit 710 accepts a unique identifier ID(D).

Specifically, the acceptance unit 710 accepts, via the input/output interface 704, the unique identifier ID(D) input to the data management device 700. However, the acceptance unit 710 may accept the unique identifier ID(D) from an application program. The acceptance unit 710 may use the communication device 705 to receive the unique identifier ID(D) from the registration request device 500 or the search request device 600.

The unique identifier ID(D) is obtained as a result of the search request process (step S160 in FIG. 9), the search operation process (step S170 in FIG. 9), or the decryption operation process (step S180 in FIG. 9).

### (Step S192 in FIG. 20: Deletion Process)

The acceptance unit 710 deletes the ciphertext CT and the encrypted tag set ETS that correspond to the unique identifier ID(D) from the storage unit 790.

### Effects of Embodiment 1

As described above, the searchable encryption system 100 according to Embodiment 1 can realize a multi-user type searchable encryption scheme using only a common-key encryption technique. In other words, a multi-user type searchable encryption scheme can be realized without using a public-key encryption technique. This allows data registration and searches to be performed at high speed.

The searchable encryption system 100 according to Embodiment 1 can set multiple attribute conditions simultaneously for a ciphertext and an encrypted tag using the logical operator OR. As a result, a searcher who is allowed to perform decryption and searches can be easily specified even with attribute conditions using the logical operator OR. Furthermore, when specifying attribute conditions using the logical operator OR, not only the data sizes of a ciphertext and an encrypted tag can be reduced, but also decryption and searches can be performed efficiently, compared to a conventional multi-user type common-key scheme. Additionally, since there is no need to distribute multiple user secret keys to a searcher, an increase in operational load can be prevented.

The searchable encryption system 100 according to Embodiment 1 generates an aggregate attribute condition σ by adding a higher-level attribute condition X′ that includes at least one of specified attribute conditions to the specified attribute conditions X. Then, the searchable encryption system 100 sets a search condition in which attribute conditions Y included in the aggregate attribute condition σ (=attribute conditions X and X′) are connected by the logical operator OR in a ciphertext and an encrypted tag. This makes it possible to realize a multi-user type common-key scheme that allows searchers who can perform decryption and searches to be efficiently specified with awareness of a hierarchical structure by using wildcards.

### Embodiment 2

Embodiment 2 differs from Embodiment 1 in that decryption of a ciphertext CT and a search for an encrypted tag ET are efficiently performed by first using encrypted attribute information to filter ciphertexts CT that can be searched for. In Embodiment 2, this difference will be described, and the description of the same aspects will be omitted.

### Description of Configuration

The configuration of the registration request device 500, the configuration of the search request device 600, and the configuration of the data management device 700 are partially different from those in Embodiment 1.

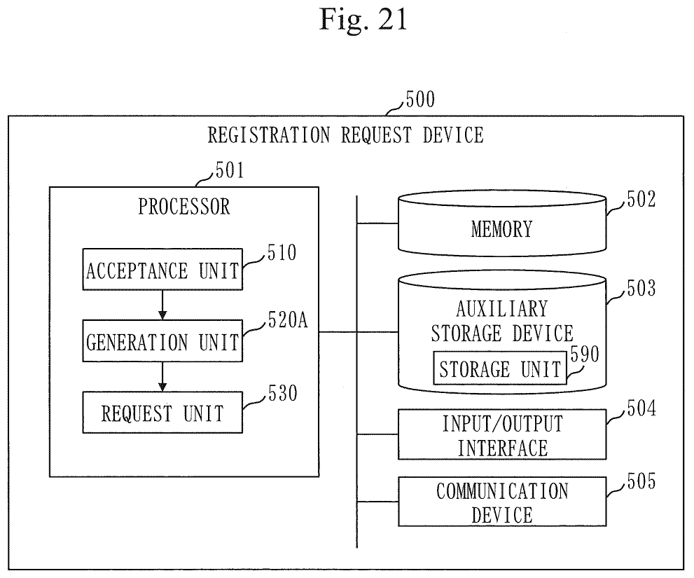

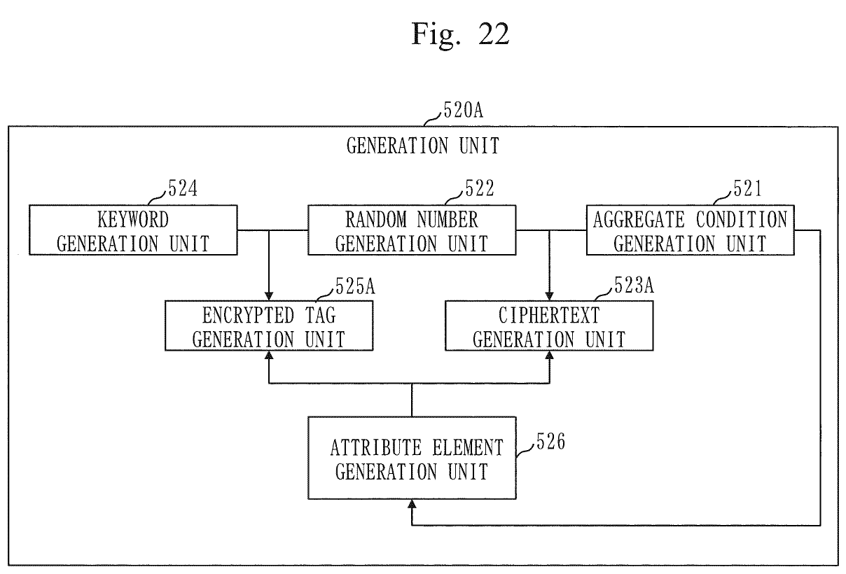

Referring to FIGS. 21 and 22, the configuration of the registration request device 500 according to Embodiment 2 will be described.

The registration request device 500 includes a generation unit 520A in place of the generation unit 520 in Embodiment 1. Specifically, as illustrated in FIG. 22, the generation unit 520A includes a ciphertext generation unit 523 A in place of the ciphertext generation unit 523, an encrypted tag generation unit 525A in place of the encrypted tag generation unit 525, and further includes an attribute element generation unit 526 additionally.

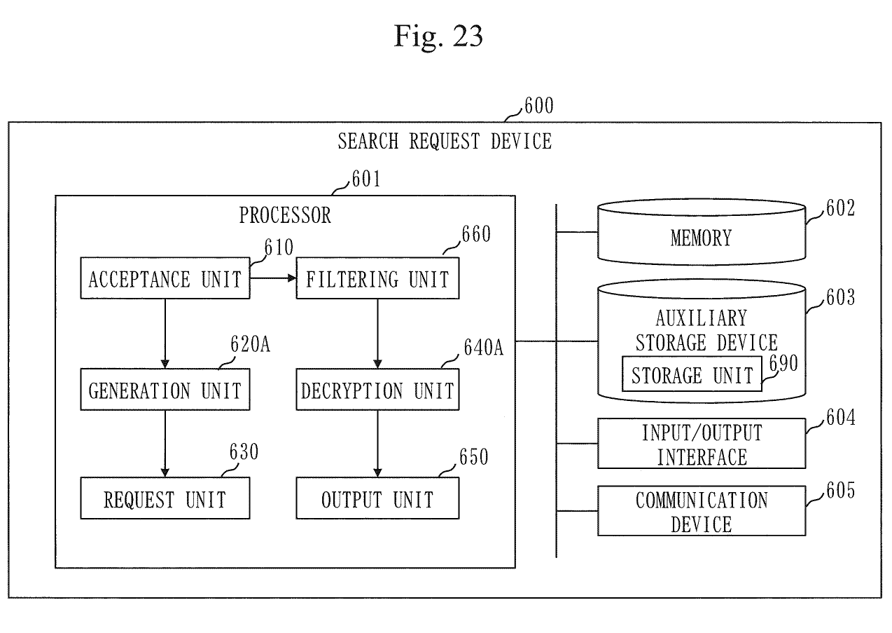

Referring to FIG. 23, the configuration of the search request device 600 according to Embodiment 2 will be described.

The search request device 600 includes a generation unit 620A in place of the generation unit 620 in Embodiment 1, a decryption unit 640A in place of the decryption unit 640, and further includes a filtering unit 660 additionally.

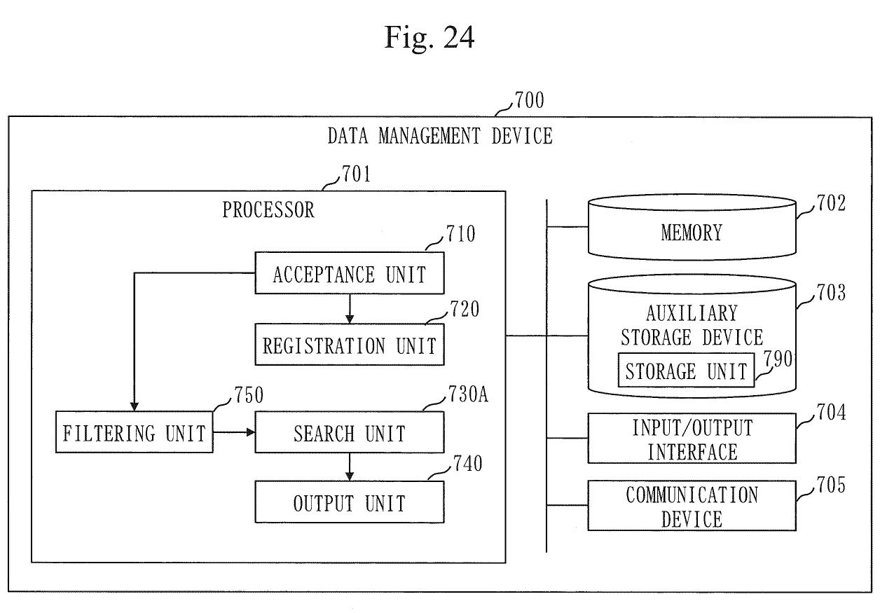

Referring to FIG. 24, the configuration of the data management device 700 according to Embodiment 2 will be described.

The data management device 700 includes a search unit 730A in place of the search unit 730 in Embodiment 1, and further includes a filtering unit 750 additionally.

### Description of Operation

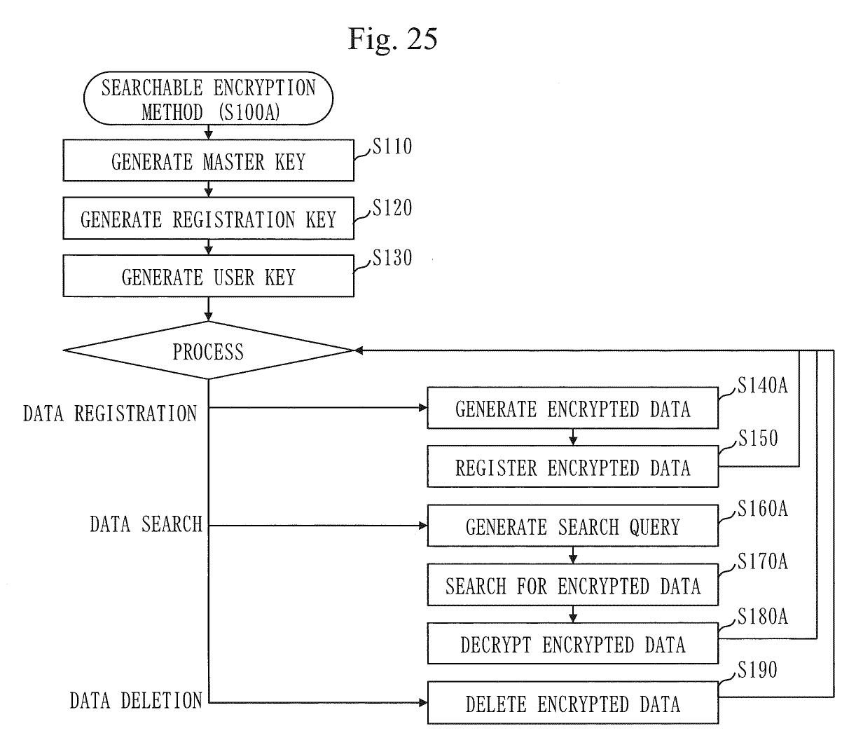

Referring to FIGS. 25 to 29, the operation of the searchable encryption system 100 according to Embodiment 2 will be described.

A procedure for the operation of the searchable encryption system 100 according to Embodiment 2 is equivalent to the searchable encryption method according to Embodiment 2. A program that realizes the operation of the searchable encryption system 100 according to Embodiment 2 is equivalent to the searchable encryption program according to Embodiment 2.

Referring to FIG. 25, overall processing by the searchable encryption system 100 according to Embodiment 2 will be described.

The processes of step S110, step S120, step S130, step S150, and step S190 are the same as those in Embodiment 1.

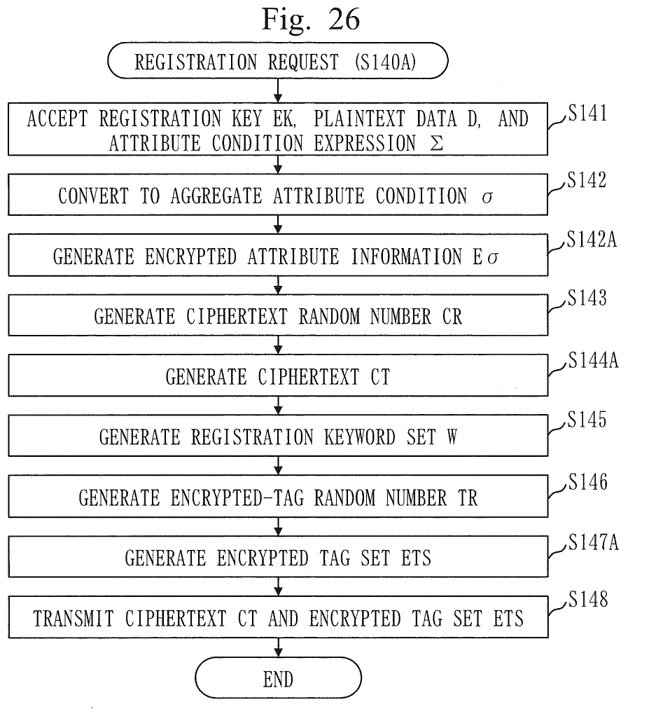

Referring to FIG. 26, the registration request process according to Embodiment 2 (step S140A in FIG. 25) will be described.

The process of step S140A corresponds to step S140 in FIG. 9. The processes of step S141, step S142, step S143, step S145, step S146, and step S148 are the same as those in Embodiment 1.

### (Step S142A in FIG. 26: Attribute Element Generation Process)

The attribute element generation unit 526 uses the aggregate attribute condition σ to generate an encrypted aggregate attribute condition Eσ.

Specifically, the attribute element generation unit 526 calculates the encrypted aggregate attribute condition Eσ as follows. The encrypted aggregate attribute condition Eσ includes J encrypted attribute conditions Eσ_j. Note that j is an integer between 1 and J, and J is the number of attribute conditions included in the aggregate attribute condition σ.

First, the attribute element generation unit 526 concatenates the registration key EK and Yj included in the aggregate attribute condition σ for each integer j of j=1, . . . , J. The value represented by the resulting bit string is called a concatenated value Yj′. Then, the ciphertext generation unit 523 executes the function F_UKA using the concatenated value Yj′ as input. The resulting value is Eσ_j.

The function F_UKA is the one-way function used in step S132 in FIG. 12.

The encrypted aggregate attribute condition Eσ can be expressed as follows.

Eσ=(Eσ1, . . . , EσJ)

Eσj=F_UKA(EK∥Yj)

### (Step S144A in FIG. 26: Ciphertext Generation Process)

The ciphertext generation unit 523A uses the registration key EK, the plaintext data D, the aggregate attribute condition σ, the encrypted aggregate attribute condition Eσ, and the ciphertext random number CR to generate a ciphertext CT.

The ciphertext CT includes J ciphertext elements CT_j, J ciphertext attributes CTA_j, a ciphertext random number s, a ciphertext verification value CTV, and a ciphertext payload CTP. Note that j is an integer between 1 and J, and J is the number of attribute conditions Y included in the aggregate attribute condition σ. The ciphertext CT also includes a unique identifier ID(D) of the plaintext data as metadata of the plaintext data D. This unique identifier ID(D) may be encrypted.

The ciphertext element CT_j, the ciphertext random number s, the ciphertext verification value CTV, and the ciphertext payload CTP are the same as those in Embodiment 1.

The ciphertext generation unit 523A sets the ciphertext attribute CTA_j as follows.

The ciphertext generation unit 523A sets the encrypted attribute condition Eσj included in the encrypted aggregate attribute condition Eσ as the ciphertext attribute CTA_j for each j of j=1, . . . , J.

The ciphertext CT can be expressed as follows. Note that “+” means an exclusive OR (XOR) in Embodiment 2.

$$CT = ( CT\_ 1 , … , CT\_J , CTA\_ 1 , … , CTA\_J , s , CTV , CTP )$$

$$CT\_j = F\_CT ( F\_UK ( EK ‖ Yj ) ‖ s ) + r$$

$$\begin{matrix}CTA\_j = E σ j \\ = F\_UKA ( EK ‖ Yj )\end{matrix}$$

$$CTV = F\_CTV ( r )$$

$$CTP = F\_CTP ( r , D )$$

### (Step S147A in FIG. 26: Encrypted Tag Generation Process)

The encrypted tag generation unit 525A uses the registration key EK, the registration keyword set W, the aggregate attribute condition σ, the encrypted aggregate attribute condition Eσ, and the encrypted-tag random number TR to generate an encrypted tag set ETS.

The encrypted tag set ETS includes I encrypted tags ETi and J encrypted tag attributes ETA_j. The i of the encrypted tag ETi is an integer between 1 and I, and I is the number of keywords included in the registration keyword set W. The j of the encrypted tag attribute ETA_j is an integer between 1 and J, and J is the number of attribute conditions included in the aggregate attribute condition σ.

The encrypted tag ETi is the same as that in Embodiment 1.

The encrypted tag generation unit 525A calculates the encrypted tag attribute ETA_j as follows.

The encrypted tag generation unit 525A sets the encrypted attribute condition Eσj included in the encrypted aggregate attribute condition Eσ as the encrypted tag attribute ETA_j for each integer j of j=1, . . . , J.

The encrypted tag set ETS can be expressed as follows.

$$ETS = ( ET 1 , … , ETI , ETA\_ 1 , … , ETA\_J , S , ETV )$$

$$ETi = ( ETi\_ 1 , … , ETi\_J )$$

$$ETi\_j = F\_ET2 ( F\_ET1 ( F\_UK ( EK ‖ Yj ) ‖ W\_i ) ‖ S ) + R$$

$$\begin{matrix}ETA\_j = E σ j \\ = F\_UKA ( EK ‖ Yj )\end{matrix}$$

$$ETV = F\_ETV ( R )$$

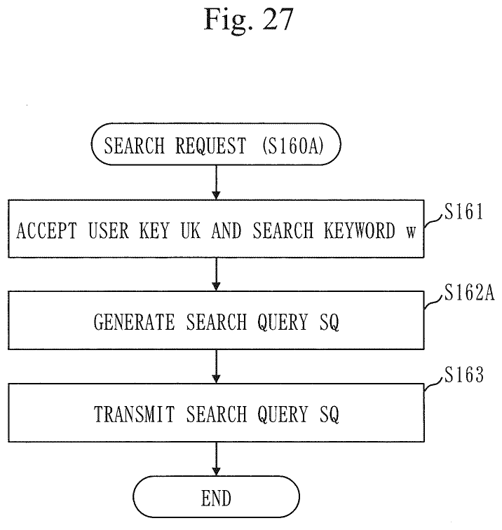

Referring to FIG. 27, the search request process according to Embodiment 2 (step S160A in FIG. 25) will be described.

The process of step S160A corresponds to step S160 in FIG. 9. Step S161 and step S163 are the same as those in Embodiment 1.

### (Step S162A in FIG. 27: Generation Process)

The generation unit 620A uses the user key UK and the search keyword w to generate a search query SQ. The search query SQ includes a search query element sq and a search query attribute sqa.

The generation unit 620A calculates the search query element sq as follows.

First, the generation unit 620A extracts the user key element uk from the user key UK. Next, the generation unit 620A concatenates the user key element uk and the search keyword w. The value represented by the resulting bit string is called a concatenated value w\hat{ }. Then, the generation unit 620A executes the function F_ET1 using the concatenated value w\hat{ } as input. The resulting value is the search query element sq.

The generation unit 620A sets the user key attribute uka of the user key UK as the search query attribute sqa.

The search query SQ can be expressed as follows.

$$SQ = ( sq , sqa )$$

$$\begin{matrix}sq = F\_ET1 ( uk ‖ w ) \\ = F\_ET1 ( F\_UK ( EK \vert \vert A \& ) ‖ w )\end{matrix}$$

$$\begin{matrix}sqa = uka \\ = F\_UKA ( EK \vert \vert A \& )\end{matrix}$$

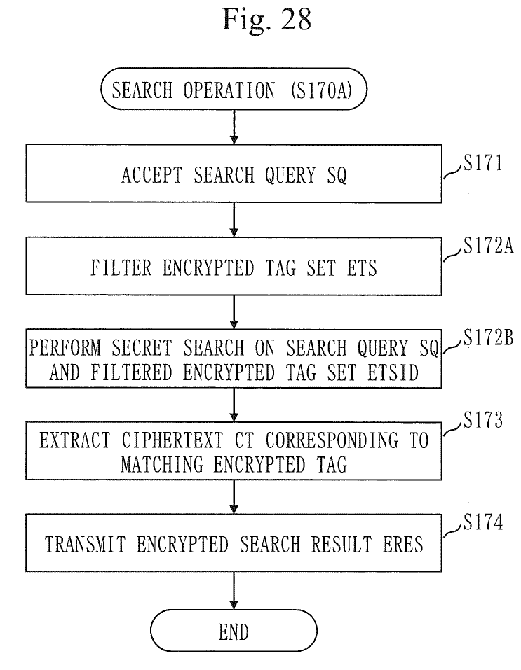

Referring to FIG. 28, the search operation process according to Embodiment 2 (step S170A in FIG. 25) will be described.

The process of step S170A corresponds to step S170 in FIG. 9.

Step S171, step S173, and step S174 are the same as those in Embodiment 1.

### (Step S172A in FIG. 28: Filtering Process)

The filtering unit 750 uses the search query attribute sqa included in the search query SQ to filter the encrypted tag set ETS.

Specifically, the filtering unit 750 searches for each encrypted tag attribute ETA_j in the encrypted tag set ETS that matches the search query attribute sqa. The filtering unit 750 extracts the unique identifier ID(D) included as the metadata and the integer j, which is the index of ETA_j, of each matching encrypted tag attribute ETA_j in the encrypted tag set ETS. A set of pairs of the extracted unique identifier ID(D) and the integer j is called a filtered encrypted tag set ETSID.

The filtered encrypted tag set ETSID can be expressed as follows. Note that K is an integer of 1 or more, and is the number of extracted integers j. Also note that j_1 to j_K are integers from 1 to J, representing the extracted integers j.

ETSID={(ID(D1), j_1), . . . , (ID(DK), j_K)}

That is, (ID(Dk), j_k) included in the filtered encrypted tag set ETSID indicates that only a special operation with the search query SQ needs to be performed only on the tag elements ET1_(j_k) to ETI_(j_k) of the encrypted tag set ETS corresponding to the unique identifier ID(Dk). That is, the target of the special operation is filtered to only the encrypted tag set ETS corresponding to the unique identifier ID(Dk) among the encrypted tag set ETS. Furthermore, the target of the special operation is filtered to only the tag element ETi_(j_k) indicated by the integer j_k among the J tag elements ETi_j for each of the I encrypted tags ETi included in the filtered encrypted tag set ETS.

In other words, in this step, the encrypted tag attribute ETA_(j_k) used in the composition of the tag elements ET1_(j_k) to ET1_(j_k) that matches the search query attribute sqa is extracted. Then, in the next step, processing is performed to check whether each of keywords W_1 to W_I included in the tag elements ET1_(j_k) to ETI_(j_k) matches the search keyword w included in the search query element sq.

The tag element ETi_(j_k), the search query element sq, the encrypted tag attribute ETA_(j_k), and the search query attribute sqa can be expressed as follows.

$$ETi\_ ( j\_k ) = F\_ET2 ( F\_ET1 ( F\_UK ( EK ‖ Yj\_k ) ‖ w\_i ) ‖ S ) + R$$

$$sq = F\_ET1 ( F\_UK ( EK ‖ A \& ) ‖ w )$$

$$ETA\_ ( j\_k ) = F\_UKA ( EK ‖ Yj\_k )$$

$$sqa = F\_UKA ( EK ‖ A \& )$$

More precisely, if the encrypted tag attribute ETA_(j_k) and the search query attribute sqa are equal, it indicates that the attribute condition Yj_k included in the tag element ETi_(j_k) and the concatenated value A& of the attribute information included in the search query element sq are equal.

### (Step S172B in FIG. 28: Search Process)

The search unit 730A uses the search query SQ to perform a secret search on each tag element ETi_(j_k) of the encrypted tag set ETS corresponding to the filtered encrypted tag set ETSID. As a result, the search unit 730A selects the encrypted tag set ETS that matches the search query SQ.

The i of the encrypted tag ETi is an integer between 1 and I, and I is the number of the encrypted tags ETi included in the encrypted tag set ETS. The j_k of the tag element ETi_(j_k) is an integer between 1 and J, and is a value included in the filtered encrypted tag set ETSID.

Specifically, the search unit 730A sets each (ID(Dk), j_k) included in the filtered encrypted tag set ETSID as target (ID(Dk), j_k). The search unit 730A sets each encrypted tag set ETS corresponding to the unique identifier ID(Dk) in the target (ID(Dk), j_k) as a target encrypted tag set ETS. For each of the I encrypted tags ETi included in the target encrypted tag set ETS, the search unit 730A sets the tag element ETi_(j_k) indicated by the integer j_k among the J tag elements ETi_j as a target tag element ETi_(j_k). Then, the search unit 730A performs the following processing on the target tag element ETi_(j_k).

First, the search unit 730A concatenates the search query element sq included in the search query SQ and the encrypted-tag random number S included in the encrypted tag set ETS corresponding to the unique identifier ID(Dk). The value represented by the resulting bit string is called a concatenated value sq\hat{ }. Next, the search unit 730A executes the function F_ET2 using the concatenated value sq\hat{ } as input. The resulting value is called a function value sq\hat{ }\hat{ }. Next, the search unit 730A calculates the exclusive OR of the function value sq\hat{ }\hat{ } and the encrypted tag ETi_(j_k). The resulting value is called a calculated value Rijk. Next, the search unit 730A executes the function F_ETV using the calculated value Rijk as input. The resulting value is called a function value Vijk.

Then, the search unit 730A checks whether the function value Vijk matches the encrypted tag verification value ETV included in the encrypted tag set ETS. If the values match, the unique identifier ID corresponding to that tag element ETi_(j_k) is extracted.

The function value sq\hat{ }\hat{ } and the calculated value Rijk obtained by the above processing can be expressed as follows.

$$\begin{matrix}sq \hat{} \hat{}= F\_ET2 ( sq ‖ S ) \\ = F\_ET2 ( F\_ET1 ( F\_UK ( EK ‖ A \& ) ‖ w ) ‖ S )\end{matrix}$$

$$\begin{matrix}Rijm = sq \hat{} \hat{} + ETi\_ ( j\_k ) \\ F\_ET2 ( F\_ET1 ( F\_UK ( EK ‖ A \& ) ‖ w ) ‖ S ) \\ + F\_ET2 ( F\_ET1 ( F\_UK ( EK ‖ Yj\_k ) ‖ W\_i ) ‖ S ) \\ + r\end{matrix}$$

If “A&=Yj_k” and “w=W_i”, that is, if “the attribute information A included in the user key UK is equal to the attribute condition Yj_k included in the encrypted tag ETi” and “the search keyword w is equal to the registration keyword W_i”, then “Rijk=R”.

Therefore, in this case, “Vijk=F_ETV(Rijk)=F_ETV(R)=ETV”.

A set of extracted unique identifiers ID is called a corresponding unique identifier set IDS.

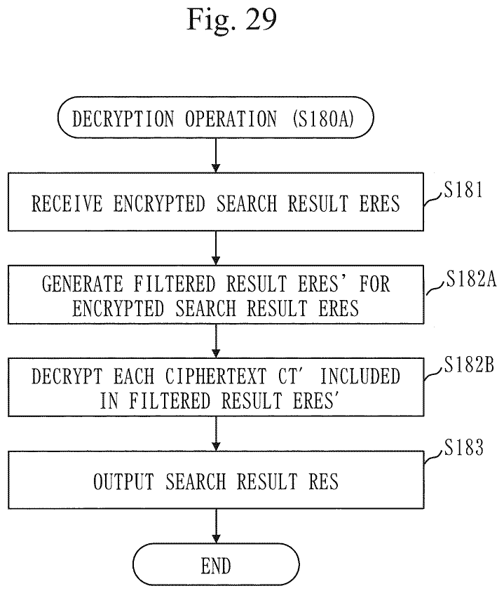

Referring to FIG. 29, the decryption operation process according to Embodiment 2 (step S180A in FIG. 25) will be described.

The process of step S180A corresponds to step S180 in FIG. 9. Step S181 and step S183 are the same as those in Embodiment 1.

### (Step S182A in FIG. 29: Filtering Process)

The filtering unit 660 uses the user key UK to generate a filtered result ERES′ by converting each ciphertext CT included in the encrypted search result ERES into a filtered ciphertext CT′.

If the encrypted search result ERES is an empty set, this step is omitted.

Specifically, the filtering unit 660 generates the filtered ciphertext CT′ by performing the following processing on each ciphertext CT included in the encrypted search result ERES.

First, the filtering unit 660 searches for a ciphertext attribute CTA_j included in the ciphertext CT that matches the user key attribute uka included in the user key UK. Note that j is an integer between 1 and J, and J is the number of ciphertext elements CTA_j included in the ciphertext CT. Next, the ciphertext element CT_j corresponding to the ciphertext attribute CTA_j that matches the user key attribute uka, the ciphertext random number s, and the ciphertext verification value CTV are extracted. Then, the filtering unit 660 combines the extracted ciphertext attribute CTA_j, ciphertext element CT_j, ciphertext random number s, and ciphertext verification value CTV to set them as the filtered ciphertext CT′. This filtered ciphertext CT′ is added to the filtered result ERES′.

In this case, the filtered ciphertext CT′ can be expressed as follows.

CT′=(CTA_j, CT_j, s, CTV)

The ciphertext element CT_j, the user key element uk, the ciphertext attribute CTA_j, and the user key attribute uka can be expressed as follows.

$$CT\_j = F\_CT ( F\_UK ( EK ‖ Yj\_k ) ‖ s ) + r$$

$$uk = F\_UK ( EK ‖ A \& )$$

$$CTA\_j = F\_UKA ( EK ‖ Yj\_k )$$

$$uka = F\_UKA ( EK ‖ A \& )$$

In other words, if the ciphertext attribute CTA_j and the user key attribute uka are equal, it indicates that the attribute condition Yj_k included in the ciphertext element CT_j and the attribute information A& included in the user key element uk are equal. As a result, it is sufficient to perform searchable encryption processing only on the ciphertext element CT_j corresponding to the ciphertext attribute CTA_j that matches the user key attribute uka without performing searchable encryption processing on all the ciphertext elements CT_j.

### (S182B in FIG. 29: Decryption Process)

The decryption unit 640A uses the user key UK to decrypt the plaintext data D from each filtered ciphertext CT′ included in the filtered result ERES′.

If the filtered result ERES′ is an empty set, this step is omitted.

Specifically, the decryption unit 640A processes each filtered ciphertext CT′ in the filtered result ERES′ as follows to perform decryption.

First, the decryption unit 640A concatenates the user key element uk included in the user key UK and the ciphertext random number s included in the filtered ciphertext CT′. The value represented by the resulting bit string is called a concatenated value uk\hat{ }. Next, the decryption unit 640A executes the function F_CT using the concatenated value uk\hat{ } as input. The resulting value is called a function value uk\hat{ }\hat{ }. Next, the decryption unit 640A calculates the exclusive OR of the function value uk\hat{ }\hat{ } and the ciphertext element CT_j included in the filtered ciphertext CT′. The resulting value is called a calculated value rj. Next, the decryption unit 640A executes the function F_CTV using the calculated value rj as input. The resulting value is called a function value vj. Next, the decryption unit 640A checks whether the function value vj matches the ciphertext verification value CTV included in the ciphertext CT.

Then, if the function value vj matches the ciphertext verification value CTV, the decryption unit 640A executes the function DEC on the ciphertext payload CTP using the calculated value rj as a key. The resulting value is the plaintext data D.

The function value uk\hat{ }\hat{ } and the calculated value rj that are obtained by the above processing can be expressed as follows.

$$\begin{matrix}uk \hat{} \hat{}= F\_CT ( uk ‖ s ) \\ = F\_CT ( F\_UK ( EK ‖ A \& ) ‖ s )\end{matrix}$$

$$\begin{matrix}rj = uk \hat{} \hat{} + CT\_j \\ = F\_CT ( F\_UK ( EK ‖ A \& ) ‖ s ) \\ + F\_CT ( F\_UK ( EK ‖ Yj ) ‖ s ) + r\end{matrix}$$

If “A&=Yj”, that is, if “the attribute information A included in the user key UK is equal to the attribute condition Yj included in the ciphertext CT”, then “rj=r”.

Therefore, in this case, “vj=F_CTV(rj)=F_CTV(r)=CTV”.

Since the integer j is filtered in step S182A to one such that “the attribute information A included in the user key UK is equal to the attribute condition Yj included in the ciphertext CT”, the decryption process can be performed at high speed unlike Embodiment 1.

### Effects of Embodiment 2

As described above, in the searchable encryption system 100 according to Embodiment 2, the encrypted tag attribute ETA_j including the encrypted attribute condition Eσj in which an attribute condition is set and encrypted is included in the encrypted tag set ETS without setting a keyword. This allows the ciphertexts CT in which attribute conditions that enable searches are set to be efficiently filtered. That is, the data on which search processing is to be performed can be filtered. As a result, searches can be performed at higher speed than in Embodiment 1.

Similarly, in the searchable encryption system 100 according to Embodiment 2, the ciphertext attribute CTA_j including the encrypted attribute condition Eσj is included in the ciphertext CT. This allows the ciphertexts CT in which attribute conditions that enable searches are set to be efficiently filtered. That is, the data to be decrypted can be filtered. As a result, decryption can be performed at higher speed than in Embodiment 1.

### Other Configurations

### Variation 1

In Embodiments 1 and 2, each functional component is realized by software. However, as Variation 1, each functional component may be realized by hardware. Differences from Embodiments 1 and 2 regarding this Variation 1 will be described.

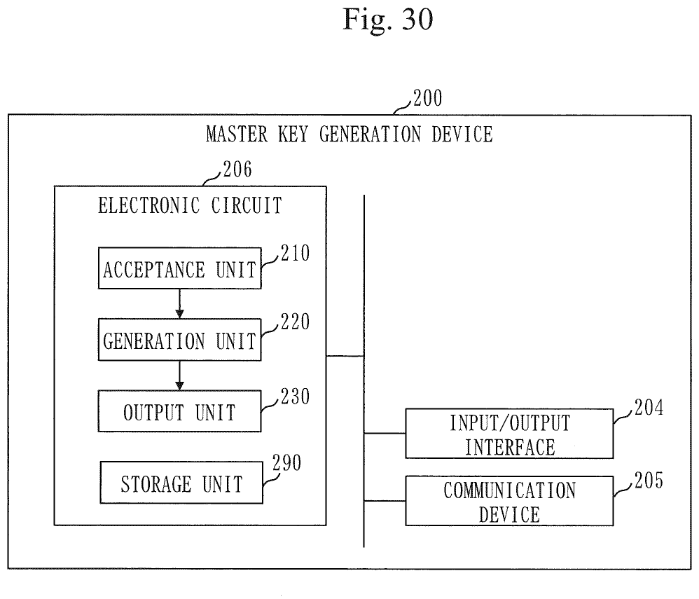

Referring to FIG. 30, a configuration of the master key generation device 200 according to Variation 1 will be described.

When each functional component is realized by hardware, the master key generation device 200 includes an electronic circuit 206 in place of the processor 201, the memory 202, and the auxiliary storage device 203. The electronic circuit 206 is a dedicated circuit that realizes the functions of each functional component of the master key generation device 200 and the functions of the memory 202 and the auxiliary storage device 203.

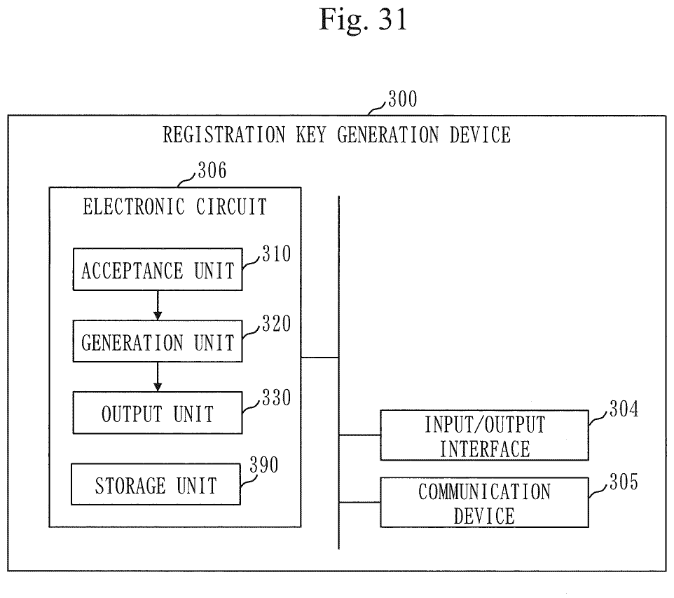

Referring to FIG. 31, a configuration of the registration key generation device 300 according to Variation 1 will be described.

When each functional component is realized by hardware, the registration key generation device 300 includes an electronic circuit 306 in place of the processor 301, the memory 302, and the auxiliary storage device 303. The electronic circuit 306 is a dedicated circuit that realizes the functions of each functional component of the registration key generation device 300 and the functions of the memory 302 and the auxiliary storage device 303.

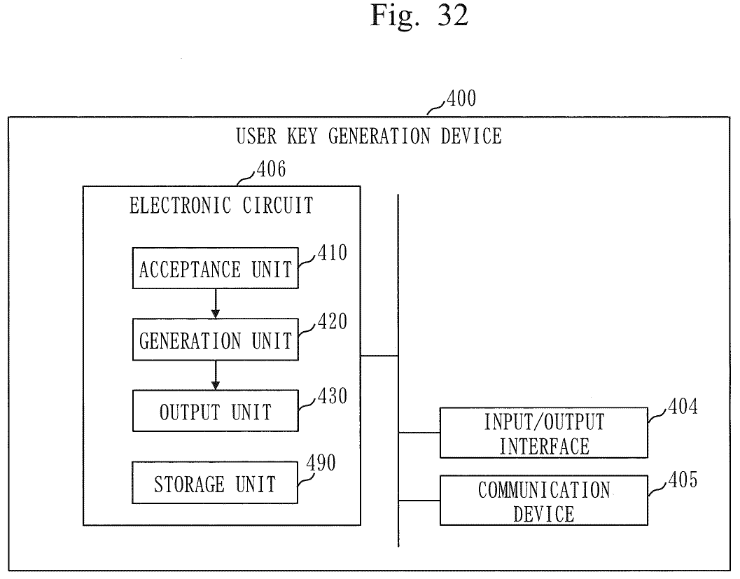

Referring to FIG. 32, a configuration of the user key generation device 400 according to Variation 1 will be described.

When each functional component is realized by hardware, the user key generation device 400 includes an electronic circuit 406 in place of the processor 401, the memory 402, and the auxiliary storage device 403. The electronic circuit 406 is a dedicated circuit that realizes the functions of each functional component of the user key generation device 400 and the functions of the memory 402 and the auxiliary storage device 403.

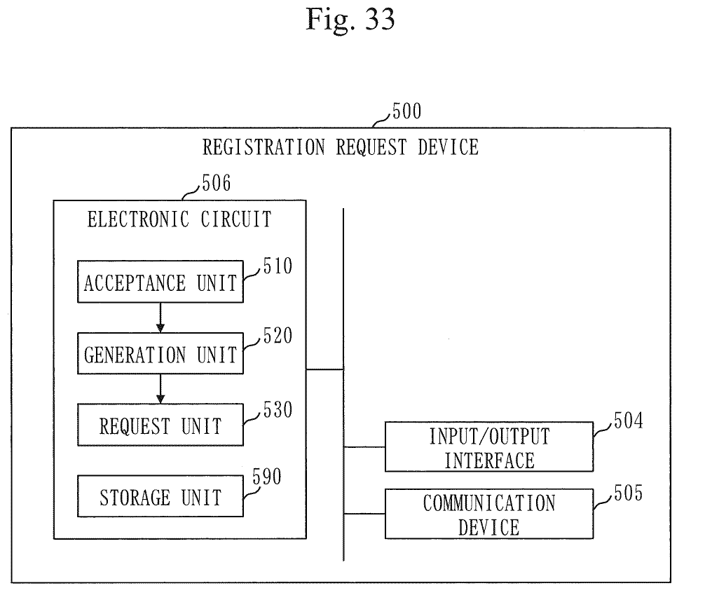

Referring to FIG. 33, a configuration of the registration request device 500 according to Variation 1 will be described.

When each functional component is realized by hardware, the registration request device 500 includes an electronic circuit 506 in place of the processor 501, the memory 502, and the auxiliary storage device 503. The electronic circuit 506 is a dedicated circuit that realizes the functions of each functional component of the registration request device 500 and the functions of the memory 502 and the auxiliary storage device 503.

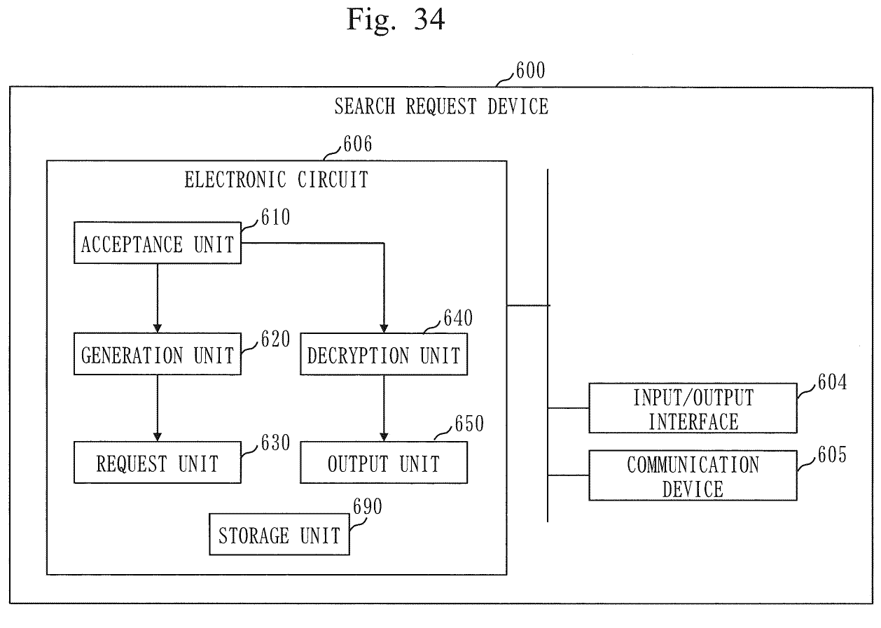

Referring to FIG. 34, a configuration of the search request device 600 according to Variation 1 will be described.

When each functional component is realized by hardware, the search request device 600 includes an electronic circuit 606 in place of the processor 601, the memory 602, and the auxiliary storage device 603. The electronic circuit 606 is a dedicated circuit that realizes the functions of each functional component of the search request device 600 and the functions of the memory 602 and the auxiliary storage device 603.

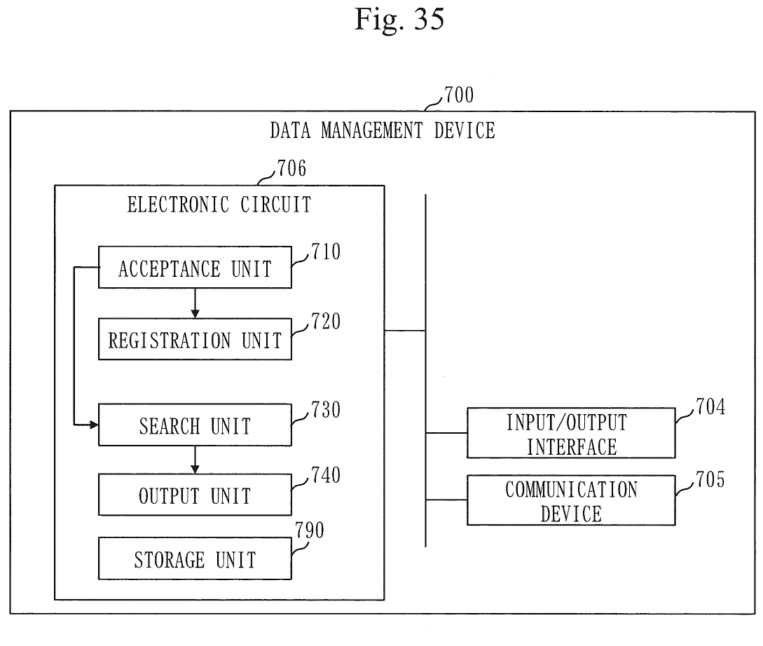

Referring to FIG. 35, a configuration of the data management device 700 according to Variation 1 will be described.

When each functional component is realized by hardware, the data management device 700 includes an electronic circuit 706 in place of the processor 701, the memory 702, and the auxiliary storage device 703. The electronic circuit 706 is a dedicated circuit that realizes the functions of each functional component of the data management device 700 and the functions of the memory 702 and the auxiliary storage device 703.

Each of the electronic circuits 206, 306, 406, 506, 606, and 706 is assumed to be a single circuit, a composite circuit, a programmed processor, a parallel-programmed processor, a logic IC, a GA, an ASIC, or an FPGA. GA stands for gate array. ASIC stands for application specific integrated circuit. FPGA stands for field-programmable gate array.

Each functional component may be realized by a single electronic circuit 206, 306, 406, 506, 606, or 706, or each functional component may be distributed across and realized by a plurality of electronic circuit 206, 306, 406, 506, 606, or 706.

### Variation 2

In Variation 2, some of the functional components may be realized by hardware and the rest of the functional components may be realized by software.

The processors 201, 301, 401, 501, 601, 701, the memories 202, 302, 402, 502, 602, 702, and the electronic circuits 206, 306, 406, 506, 606, 706 are referred to as processing circuitry. That is, the functions of each functional component is realized by the processing circuitry.

The term “unit” in the above description may be replaced with “circuit,” “step”, “procedure”, “process”, or “processing circuitry”.

The embodiments and variations of the present disclosure have been described above. Two or more of these embodiments and variations may be implemented in combination. Any one or two or more of them may be partially implemented. The present disclosure is not limited to the above embodiments and variations, and various changes can be made as needed.

### REFERENCE SIGNS LIST

100: searchable encryption system; 101: network; 200: master key generation device; 201: processor; 202: memory; 203: auxiliary storage device; 204: input/output interface; 205: communication device; 210: acceptance unit; 220: generation unit; 230: output unit; 290: storage unit; 300: registration key generation device; 301: processor; 302: memory; 303: auxiliary storage device; 304: input/output interface; 305: communication device; 310: acceptance unit; 320: generation unit; 330: output unit; 390: storage unit; 400: user key generation device; 401: processor; 402: memory; 403: auxiliary storage device; 404: input/output interface; 405: communication device; 410: acceptance unit; 420: generation unit; 430: output unit; 490: storage unit; 500: registration request device; 501: processor; 502: memory; 503: auxiliary storage device; 504: input/output interface; 505: communication device; 510: acceptance unit; 520: generation unit; 520A: generation unit; 521: aggregate condition generation unit; 522: random number generation unit; 523: ciphertext generation unit; 523A: ciphertext generation unit; 524: keyword generation unit; 525: encrypted tag generation unit; 525A: encrypted tag generation unit; 526: attribute element generation unit; 530: request unit; 590: storage unit; 600: search request device; 601: processor; 602: memory; 603: auxiliary storage device; 604: input/output interface; 605: communication device; 610: acceptance unit; 620: generation unit; 620A: generation unit; 630: request unit; 640: decryption unit; 640A: decryption unit; 650: output unit; 660: filtering unit; 690: storage unit; 700: data management device; 701: processor; 702: memory; 703: auxiliary storage device; 704: input/output interface; 705: communication device; 710: acceptance unit; 720: registration unit; 730: search unit; 740: output unit; 750: filtering unit; 790: storage unit.

1. A registration request device comprising
processing circuitry to:
generate an aggregate attribute condition by adding a higher-level attribute condition that includes at least one of a plurality of attribute conditions indicating attributes that enable a search for a ciphertext to the plurality of attribute conditions; and
generate an encrypted tag indicating a search condition in which attribute conditions included in the aggregate attribute condition are connected by a logical operator OR, the encrypted tag being used to realize a search for the ciphertext.

2. The registration request device according to claim 1,
wherein the processing circuitry sets each attribute condition included in the aggregate attribute condition as a target attribute condition, sets each of one or more keywords for searching for the ciphertext as a target keyword, and generates the encrypted tag including a tag element in which the target attribute condition and the target keyword are set and encrypted.

3. The registration request device according to claim 2,
wherein the processing circuitry generates the encrypted tag including an exclusive OR of a bit string in which the target attribute condition and the target keyword are set and encrypted and a random number R.

4. The registration request device according to claim 3,
wherein the processing circuitry generates the encrypted tag including a tag verification value obtained by executing a one-way function using the random number R as input.

5. The registration request device according to claim 2,
wherein the processing circuitry sets each attribute condition included in the aggregate attribute condition as a target attribute condition, and generates an encrypted tag attribute including an encrypted attribute condition in which the target attribute condition is set and encrypted, without setting the keyword.

6. The registration request device according to claim 1,
wherein the processing circuitry generates the ciphertext by setting a decryption condition in which attribute conditions included in the aggregate attribute condition are connected by a logical operator OR in plaintext data and then encrypting the plaintext data.

7. A search request device to request a search from a data management device that stores an encrypted tag in association with a target ciphertext, where the target ciphertext is each of a plurality of ciphertexts, the encrypted tag indicating a search condition in which each of a plurality of attribute conditions indicating attributes that enable a search for the target ciphertext and a higher-level attribute condition including at least one of the plurality of attribute conditions are connected by a logical operator OR, and being used to realize a search for the target ciphertext, the search request device comprising
processing circuitry to transmit a search query in which attribute information indicating an attribute of a searcher is set and encrypted to the data management device, and request a ciphertext whose associated encrypted tag indicates the search condition satisfied by the attribute information among the plurality of ciphertexts.

8. A registration request method comprising:
generating an aggregate attribute condition by adding a higher-level attribute condition that includes at least one of a plurality of attribute conditions indicating attributes that enable a search for a ciphertext to the plurality of attribute conditions; and
generating an encrypted tag indicating a search condition in which attribute conditions included in the aggregate attribute condition are connected by a logical operator OR, the encrypted tag being used to realize a search for the ciphertext.

9. A search request method for requesting a search from a data management device that stores an encrypted tag in association with a target ciphertext, where the target ciphertext is each of a plurality of ciphertexts, the encrypted tag indicating a search condition in which each of a plurality of attribute conditions indicating attributes that enable a search for the target ciphertext and a higher-level attribute condition including at least one of the plurality of attribute conditions are connected by a logical operator OR, and being used to realize a search for the target ciphertext, the search request method comprising
transmitting a search query in which attribute information indicating an attribute of a searcher is set and encrypted to the data management device, and requesting a ciphertext whose associated encrypted tag indicates the search condition satisfied by the attribute information among the plurality of ciphertexts.

10. A data management method comprising:
accepting a search query in which attribute information indicating an attribute of a searcher is set and encrypted; and
searching for a ciphertext whose associated encrypted tag indicates a search condition satisfied by the attribute information that is set in the search query from a storage device that stores an encrypted tag in association with a target ciphertext, where the target ciphertext is each of a plurality of ciphertexts, the encrypted tag indicating a search condition in which each of a plurality of attribute conditions indicating attributes that enable a search for the target ciphertext and a higher-level attribute condition including at least one of the plurality of attribute conditions are connected by a logical operator OR, and being used to realize a search for the target ciphertext.
